(19) United States
(12) Patent Application Publication
(10) Pub. No.: US 2026/0179639 A1
(43) Pub. Date: Jun. 25, 2026

(54) METHOD OF REMOVING TARGET SOUND FROM INPUT AUDIO AND ELECTRONIC DEVICE THEREFOR

(71) Applicant: SAMSUNG ELECTRONICS CO., LTD., Suwon-si (KR)

(72) Inventors: Deokjun Eom, Suwon-si (KR); Woohyun Nam, Suwon-si (KR); Nahyun Kim, Suwon-si (KR); Kyungrae Kim, Suwon-si (KR)

(73) Assignee: SAMSUNG ELECTRONICS CO., LTD., Suwon-si (KR)

(21) Appl. No.: 19/361,504

(22) Filed: Oct. 17, 2025

Related U.S. Application Data
(63) Continuation of application No. PCT/KR2025/016482, filed on Oct. 17, 2025.

(30) Foreign Application Priority Data
Oct. 18, 2024 (KR) 10-2024-0143269
Sep. 8, 2025 (KR) 10-2025-0127704

(51) Int. Cl. G10L 21/0232; G06N 3/04; G10L 25/18

(52) U.S. Cl. CPC G10L 21/0232; G06N 3/04; G10L 25/18

(57) ABSTRACT

A method, performed by an electronic device, of removing a target sound from input audio may include obtaining a first output audio based on removing the target sound from the input audio by using an artificial intelligence model; obtaining residual audio including the target sound, based on a difference between the input audio and the first output audio; estimating features of the target sound based on the residual audio; determining harmonic components of the target sound in the first output audio, based on the estimated features of the target sound; and obtaining second output audio based on reducing magnitudes of the harmonic components in the first output audio.

### CROSS-REFERENCES TO RELATED APPLICATIONS

This application is a continuation of International Application No. PCT/KR2025/016482, filed on Oct. 17, 2025, with the Korean Intellectual Property Office, which claims priority to Korean Patent Application No. 10-2024-0143269, filed on Oct. 18, 2024, and Korean Patent Application No. 10-2025-0127704, filed on Sep. 8, 2025, filed with the Korean Intellectual Property Office, the disclosures of which are incorporated herein by reference in their entireties.

### TECHNICAL FIELD

The disclosure relates to a method of removing a target sound from input audio and an electronic device therefor.

### BACKGROUND

Target sounds generated by an electronic device, such as system sounds (e.g., notification sounds or alarm sounds), are output to inform a user of an operating state of the electronic device. These target sounds may be an unnecessary component in input audio, and accordingly, there is a trend for electronic devices to remove a target sound from the input audio to provide the user with high-quality video. Accordingly, there is an increasing need for technology that minimizes residual components resulting from target sounds by precisely detecting and removing or attenuating the target sounds within the input audio.

### SUMMARY

According to an embodiment of the disclosure, a method, performed by an electronic device, of removing a target sound from input audio may include obtaining a first output audio based on removing the target sound from the input audio by using an artificial intelligence model; obtaining residual audio including the target sound, based on a difference between the input audio and the first output audio; estimating features of the target sound based on the residual audio; determining harmonic components of the target sound in the first output audio, based on the estimated features of the target sound; and obtaining second output audio based on reducing magnitudes of the harmonic components in the first output audio.

According to an embodiment of the disclosure, an electronic device may include memory storing instructions, and at least one processor operatively coupled to the memory and including processing circuitry. The at least one processor may individually or collectively execute the instructions to cause the electronic device to obtain first output audio based on removing a target sound from the input audio by using an artificial intelligence model; obtain residual audio including the target sound, based on a difference between the input audio and the first output audio; estimate features of the target sound based on the residual audio; determine harmonic components of the target sound within the first output audio, based on the estimated features of the target sound; and obtain second output audio based on reducing magnitudes of the harmonic components in the first output audio.

According to an embodiment of the disclosure, a non-transitory computer-readable medium storing instructions, where the instructions when executed by at least one processor of an electronic device, collectively or individually, causes the electronic device to obtain first output audio based on removing a target sound from the input audio by using an artificial intelligence model; obtain residual audio including the target sound, based on a difference between the input audio and the first output audio; estimate features of the target sound based on the residual audio; determine harmonic components of the target sound within the first output audio, based on the estimated features of the target sound; and obtain second output audio based on reducing magnitudes of the harmonic components in the first output audio.

### BRIEF DESCRIPTION OF THE DRAWINGS

The disclosure may be understood with a combination of the following detailed descriptions and the accompanying drawings, wherein reference numbers refer to structural elements.

FIG. 1 is a diagram schematically illustrating a method of removing a target sound from input audio, according to an embodiment of the disclosure.

FIG. 2 is a flowchart illustrating a process, performed by an electronic device, of removing a target sound from input audio, according to an embodiment of the disclosure.

FIG. 3 is a diagram illustrating an operation, performed by an electronic device, of removing a target sound from input audio, according to an embodiment of the disclosure.

FIG. 4A is a flowchart illustrating a process, performed by an electronic device, of obtaining first output audio by using an artificial intelligence model, according to an embodiment of the disclosure.

FIG. 4B is a diagram illustrating an operation, performed by an electronic device, of obtaining first output audio by using an artificial intelligence model, according to an embodiment of the disclosure.

FIG. 5A is a diagram illustrating a process of generating a training dataset for an artificial intelligence model, according to an embodiment of the disclosure.

FIG. 5B is a diagram illustrating an operation of performing pre-training of an artificial intelligence model, according to an embodiment of the disclosure.

FIG. 6 is a diagram illustrating a process, performed by an electronic device, of obtaining residual audio, according to an embodiment of the disclosure.

FIG. 7 is a flowchart illustrating a process, performed by an electronic device, of estimating features of a target sound, according to an embodiment of the disclosure.

FIG. 8A is a diagram illustrating an operation, performed by an electronic device, of estimating features of a target sound, according to an embodiment of the disclosure.

FIG. 8B is a diagram illustrating an operation, performed by an electronic device, of estimating features of a target sound, according to an embodiment of the disclosure.

FIG. 8C is a diagram illustrating an operation, performed by an electronic device, of estimating features of a target sound, according to an embodiment of the disclosure.

FIG. 9 is a flowchart illustrating a process, performed by an electronic device, of searching for harmonic components within first output audio, according to an embodiment of the disclosure.

FIG. 10A is a diagram illustrating an operation, performed by an electronic device, of searching for harmonic components within first output audio, according to an embodiment of the disclosure.

FIG. 10B is a diagram illustrating an operation, performed by an electronic device, of searching for harmonic components within first output audio, according to an embodiment of the disclosure.

FIG. 11 is a flowchart illustrating a method, performed by an electronic device, of determining a harmonic region within first output audio, according to an embodiment of the disclosure.

FIG. 12A is a diagram illustrating an operation, performed by an electronic device, of determining a harmonic region within first output audio, according to an embodiment of the disclosure.

FIG. 12B is a diagram illustrating an operation, performed by an electronic device, of determining a harmonic region within first output audio, according to an embodiment of the disclosure.

FIG. 13A is a flowchart illustrating a process, performed by an electronic device, of obtaining second output audio in which magnitudes of harmonic components have been reduced, according to an embodiment of the disclosure.

FIG. 13B is a diagram illustrating an operation, performed by an electronic device, of obtaining second output audio in which magnitudes of harmonic components have been reduced, according to an embodiment of the disclosure.

FIG. 14A is a flowchart illustrating a process, performed by an electronic device, of obtaining second output audio in which magnitudes of harmonic components have been reduced, according to an embodiment of the disclosure.

FIG. 14B is a diagram illustrating an operation, performed by an electronic device, of obtaining second output audio in which magnitudes of harmonic components have been reduced, according to an embodiment of the disclosure.

FIG. 15 is a diagram illustrating an operation, performed by an electronic device, of removing a target sound from input audio, according to an embodiment of the disclosure.

FIG. 16A is a diagram illustrating an operation, performed by an electronic device, of removing a target sound from input audio, according to an embodiment of the disclosure.

FIG. 16B is a diagram illustrating an operation, performed by an electronic device, of removing a target sound and harmonic components of the target sound from input audio, according to an embodiment of the disclosure.

FIG. 17A is a diagram illustrating an operation, performed by an electronic device, of removing a target sound from input audio, according to an embodiment of the disclosure.

FIG. 17B is a diagram illustrating an operation, performed by an electronic device, of removing a target sound and harmonic components of the target sound from input audio, according to an embodiment of the disclosure.

FIG. 18 is a diagram illustrating an operation, performed by an electronic device, of removing a target sound from input audio, according to an embodiment of the disclosure.

FIG. 19 is a block diagram schematically illustrating a configuration of an electronic device according to an embodiment of the disclosure.

### DETAILED DISCLOSURE

Terms used herein will be briefly described, and then an embodiment of the disclosure will be described in detail.

Throughout the disclosure, unless otherwise specified, “or” is inclusive and not exclusive. Therefore, unless explicitly indicated otherwise or the context indicates otherwise, “A or B” may indicate “A, B, or both”.

As used herein, the expression “at least one of a, b, or c” may refer to “a”, “b”, “c”, “a and b”, “a and c”, “b and c”, “a, b, and c”, or variations thereof.

Although the terms used herein are selected from among common terms that are currently widely used in consideration of their functions in an embodiment of the disclosure, the terms may be different according to an intention of one of ordinary skill in the art, a precedent, or the advent of new technology. Also, in particular cases, the terms are discretionally selected by the applicant of the disclosure, in which case, the meaning of those terms will be described in detail in the corresponding description of an embodiment of the disclosure. Therefore, the terms used herein are not merely designations of the terms, but the terms are defined based on the meaning of the terms and content throughout the disclosure.

The singular expression may also include the plural meaning as long as it is not inconsistent with the context. All the terms used herein, including technical and scientific terms, may have the same meanings as those generally understood by those of skill in the art related to the present specification.

Throughout the disclosure, when a part “includes” an element, it is to be understood that the part may additionally include other elements rather than excluding other elements as long as there is no particular opposing recitation. In addition, as used herein, the terms such as “ . . . er (or)”, “ . . . unit”, “ . . . module”, etc., denote a unit that performs at least one function or operation, which may be implemented as hardware or software or a combination thereof.

As used herein, the expression “configured to” may be interchangeably used with, for example, “suitable for”, “having the capacity to”, “designed to”, “adapted to”, “made to”, or “capable of”, according to a situation. The expression “configured to” may not imply only “specially designed to” in a hardware manner. Instead, in a certain circumstance, the expression “a system configured to” may indicate the system “capable of” together with another device or components. For example, “a processor configured (or set) to perform A, B, and C” may imply a dedicated processor (e.g., an embedded processor) for performing a corresponding operation or a general-purpose processor (e.g., central processing unit (CPU) or an application processor) capable of performing corresponding operations by executing one or more software programs stored in memory.

In addition, in the disclosure, it should be understood that when components are “connected” or “coupled” to each other, the elements may be directly connected or coupled to each other, but may alternatively be connected or coupled to each other with an element therebetween, unless specified otherwise.

It should be understood that blocks in each flowchart, and combinations of flowcharts may be performed by one or more computer programs including computer-executable instructions. The one or more computer programs may be all stored in a single memory unit, or may be divided and stored in a plurality of different memory units.

All functions or operations described herein may be performed by a single processor or a combination of processors. The processor or the combination of processors may be circuitry configured to perform processing, and may include circuitry such as an application processor (AP), a communication processor (CP), a graphics processing unit (GPU), a neural processing unit (NPU), a microprocessor unit (MPU), a system-on-chip (SoC), or an integrated circuit (IC).

Functions associated with artificial intelligence according to the disclosure are performed by a processor and memory. The processor may include one or more processors. In this case, the one or more processors may include a general-purpose processor, such as a CPU, an AP, or a digital signal processor (DSP), a dedicated graphics processor such as a GPU or a vision processing unit (VPU), or a dedicated artificial intelligence processor such as an NPU. The one or more processors perform control to process input data according to predefined operation rules or an artificial intelligence model stored in the memory. Alternatively, in a case in which the one or more processors are dedicated artificial intelligence processors, the dedicated artificial intelligence processors may be designed with a hardware structure specialized for processing a particular artificial intelligence model.

The predefined operation rules or artificial intelligence model is generated via a training process. Here, being generated via a training process may mean that predefined operation rules or artificial intelligence model set to perform desired characteristics (or purposes), is generated by training a basic artificial intelligence model by using a learning algorithm that utilizes a large amount of training data. The training process may be performed by a device itself on which artificial intelligence according to the disclosure is performed, or by a separate server and/or system. Examples of learning algorithms may include, for example, supervised learning, unsupervised learning, semi-supervised learning, and reinforcement learning, but are not limited thereto.

The artificial intelligence model may include a plurality of neural network layers. Each of the neural network layers has a plurality of weight values, and performs a neural network arithmetic operation via an arithmetic operation between an arithmetic operation result of a previous layer and the plurality of weight values. The plurality of weight values in each of the plurality of neural network layers may be optimized as a result of training the artificial intelligence model. For example, the plurality of weight values may be updated to reduce or minimize a loss or cost value obtained by the artificial intelligence model during a training process. An artificial neural network may include, for example, a deep neural network (DNN) and may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), a deep Q-network, or the like, but is not limited thereto.

Hereinafter, an embodiment of the disclosure will be described in detail with reference to the accompanying drawings to allow those of skill in the art to easily carry out the embodiment of the disclosure. An embodiment of the disclosure may, however, be embodied in many different forms and should not be construed as being limited to the embodiment of the disclosure set forth herein. Furthermore, in the drawings, portions that are irrelevant to the description are omitted to clearly describe an embodiment of the disclosure, and like reference numerals are assigned to like elements throughout the disclosure.

Hereinafter, embodiments of the disclosure will be described in detail with reference to the drawings.

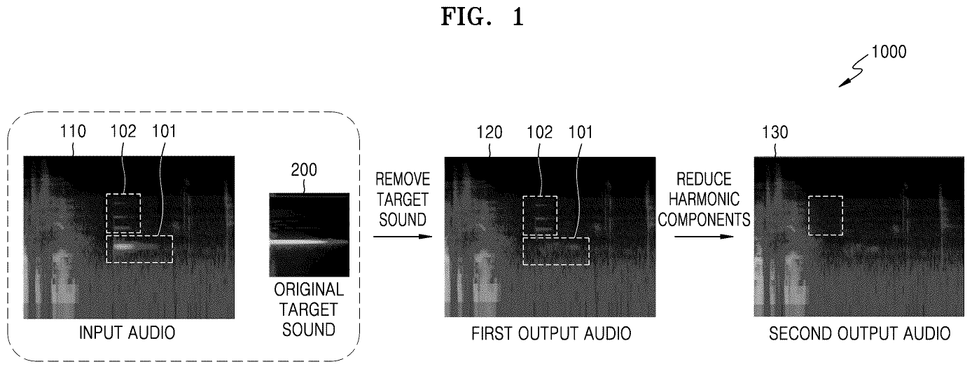

FIG. 1 is a diagram schematically illustrating a method of removing a target sound 101 from input audio 110, according to an embodiment of the disclosure.

Referring to FIG. 1, an electronic device 1000 according to an embodiment of the disclosure may be a device capable of processing the input audio 110. For example, the electronic device 1000 may be a device capable of removing a particular sound from the input audio 110. The particular sound may be a sound designated for removal by a user or a system. Hereinafter, a sound to be removed may be referred to as the target sound 101.

In an embodiment of the disclosure, the electronic device 1000 may be a device capable of playing audio. For example, the electronic device 1000 may be a device capable of playing audio data stored in a digital format through a digital-to-analog conversion unit and an amplification unit, to a sound output unit such as a speaker or earphones.

In an embodiment of the disclosure, the electronic device 1000 may be a device capable of providing audio and video simultaneously. For example, the electronic device 1000 may play a file (e.g., a video file) in which video data and audio data are recorded together, and in this case, the electronic device 1000 may process the audio data to play sound through an audio output unit, while simultaneously outputting the video to a screen. For example, the electronic device 1000 may be implemented as various types of electronic devices, such as a mobile device, a smart phone, a monitor, a laptop computer, a tablet personal computer (PC), a wearable device, a head-mounted display (HMD) device, or a digital signage. For example, the electronic device 1000 may be a device capable of capturing video and providing the captured video along with recorded audio.

In an embodiment of the disclosure, the electronic device 1000 may obtain the input audio 110. For example, the input audio 110 may be audio included in video captured by the electronic device 1000 or an external device. In this case, the input audio 110 may include all sounds recorded with the video (e.g., a voice, a background sound, or ambient noise). For example, the input audio 110 may be audio recorded by the electronic device 1000 or an external device. In this case, the input audio 110 may include sounds independently recorded through a device such as a microphone (e.g., a voice, a background sound, or ambient noise).

In an embodiment of the disclosure, the target sound 101 may refer to a particular sound to be removed from original audio. The target sound 101 may encompass sounds that may be defined according to a user's intention, such as a voice, particular background music, or machine noise. The target sound 101 may be defined as a set of sounds having identifiable characteristics. The target sound 101 may have a unique pattern distinguishable from other audio components by its frequency and temporal characteristics.

In an embodiment of the disclosure, the target sound 101 may be a system sound of the electronic device 1000 (or an external device). System sounds may refer to sounds generated by the electronic device 1000 (or an external device), such as a notification sound or a shutter sound. For example, the target sound 101 may include a system notification sound (e.g., a video recording start sound, a video recording end sound, or a camera shutter sound), a vibration notification sound, or the like. However, examples of the target sound 101 are not limited thereto, and may include any sound that has identifiable characteristics and may thus be a target for removal.

In an embodiment of the disclosure, based on the input audio 110 and an original target sound 200, the electronic device 1000 may obtain first output audio 120 resulting from removing or attenuating the target sound 101 in the input audio 110.

In an embodiment of the disclosure, the original target sound 200 may correspond to an audio sample obtained by independently playing a target sound under a particular acoustic environment (e.g., an anechoic chamber, an indoor environment, or an outdoor environment) or particular recording conditions (e.g., a fixed microphone position, a constant distance, or a fixed device setting), and collecting the resulting signal by using an actual recording device.

In an embodiment of the disclosure, the electronic device 1000 may obtain information about the original target sound 200. For example, information about the original target sound 200 may be stored in memory of the electronic device 1000 or in a predefined database, and the electronic device 1000 may obtain the information about the original target sound 200 by loading or referencing the information stored in the memory or database. Alternatively, for example, the electronic device 1000 may receive information about the original target sound 200 from an external server or an external electronic device.

In an embodiment of the disclosure, the obtained information about the original target sound 200 may be data in the form of a spectrogram. For example, the information about the original target sound 200 may include time information, frequency information, and energy (or intensity) information.

In an embodiment of the disclosure, the electronic device 1000 may input the input audio 110 and the original target sound 200 to an artificial intelligence model to obtain the first output audio 120 resulting from removing or attenuating the target sound 101 in the input audio 110.

In an embodiment of the disclosure, the first output audio 120 (or the input audio 110) may include not only the target sound 101 but also harmonic components 102 of the target sound 101. The harmonic components 102 of the target sound 101 may result from waveform distortion, which occurs when the fundamental frequency (fₒ) of the target sound 101 passes through a non-linear medium or a non-linear signal path during an actual audio output process. For example, waveform distortion may occur due to non-linear driving characteristics of a speaker, a saturation operation of an amplifier circuit, or non-linear acoustic radiation characteristics arising from a housing and a duct structure in which the speaker is mounted. Due to this waveform distortion, the harmonic components 102 corresponding to integer multiples (e.g., 2fₒ, 3fₒ, . . . ) of the fundamental frequency (fₒ) of the target sound 101 may be generated. When the harmonic components 102 of the target sound 101 remain in audio, reverberation or residual sound may be perceived in the actual audio.

In an embodiment of the disclosure, the artificial intelligence model may be stored (or installed) in the electronic device 1000, and in this case, the artificial intelligence model may be a lightweight model for removing the target sound 101. When the target sound 101 is distorted, the lightweight artificial intelligence model may fail to recognize the distorted portion and thus may be unable to remove it from the input audio 110. For example, the lightweight artificial intelligence model may fail to recognize the harmonic components 102 of the target sound 101 and may thus be unable to remove them from the input audio 110, and consequently, the harmonic components 102 may remain in the first output audio 120.

In an embodiment of the disclosure, the electronic device 1000 may obtain second output audio 130 resulting from removing the harmonic components 102 of the target sound 101 from the first output audio 120.

In an embodiment of the disclosure, the electronic device 1000 may estimate features of the target sound 101 within the input audio 110, based on residual audio obtained by removing the first output audio 120 from the input audio 110. Based on the estimated features of the target sound 101, the electronic device 1000 may search for the harmonic components 102 of the target sound 101 within the first output audio 120. By removing or attenuating the searched harmonic components 102 within the first output audio 120, the electronic device 1000 may generate the second output audio 130 in which the harmonic components 102 of the target sound 101 have been removed or attenuated.

According to an embodiment of the disclosure, the electronic device 1000 may first remove the target sound 101 by using an artificial intelligence model, and then additionally remove or attenuate the harmonic components 102 of the target sound 101, thereby obtaining final output audio (i.e., the second output audio 130) resulting from more effectively removing or attenuating the target sound 101 from the input audio 110.

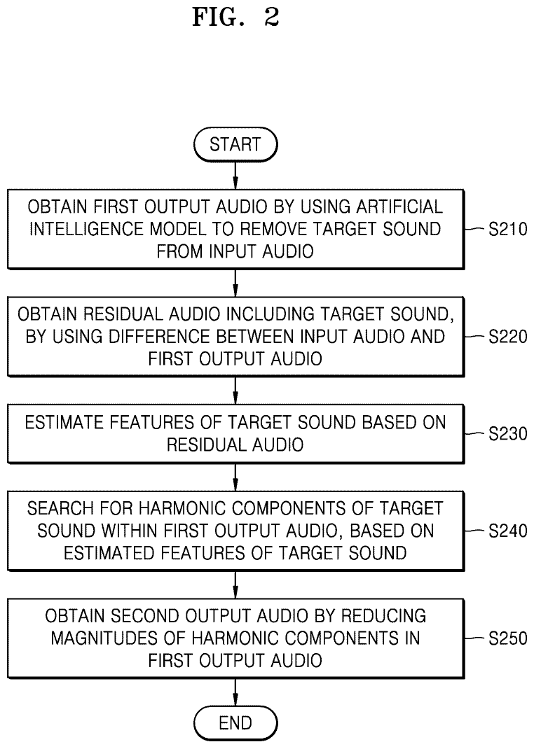

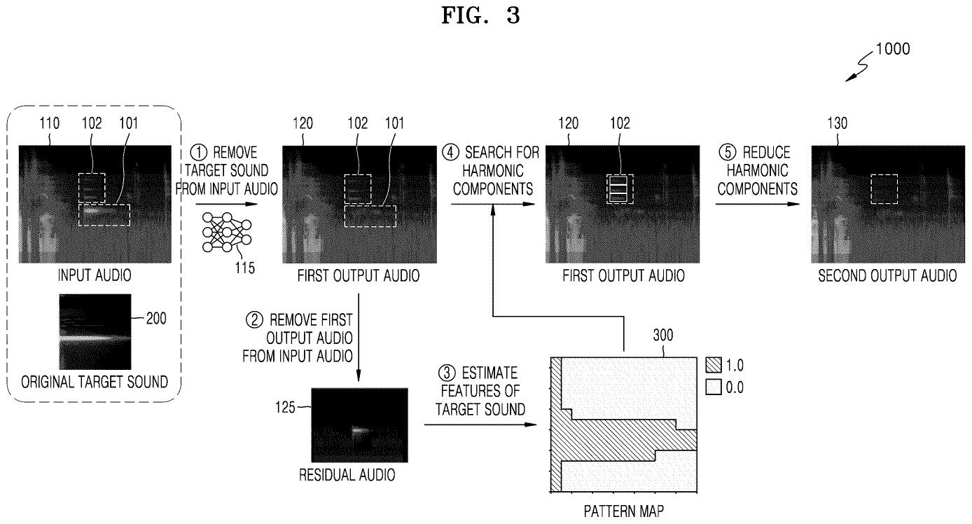

FIG. 2 is a flowchart illustrating a method, performed by the electronic device 1000, of removing a target sound from the input audio 110, according to an embodiment of the disclosure. FIG. 3 is a diagram illustrating an operation, performed by the electronic device 1000, of removing a target sound from the input audio 110, according to an embodiment of the disclosure.

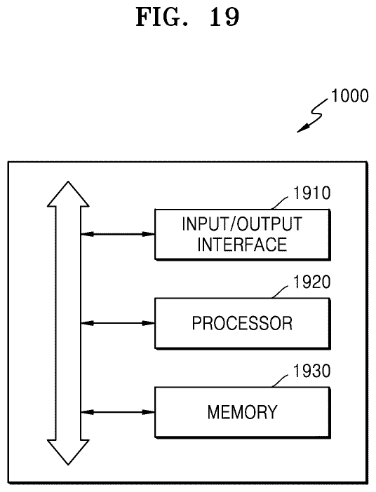

Referring to FIG. 2, a method, performed by the electronic device 1000, of removing the target sound 101 from the input audio 110 may include operations S210 to S250. In an embodiment of the disclosure, operations S210 to S250 may be performed by at least one processor 1920 (see FIG. 19) included in the electronic device 1000. The method of removing the target sound 101 from the input audio 110 is not limited to that illustrated in FIG. 2, and in one or more embodiments, the method may further include operations not illustrated in FIG. 2.

Hereinafter, with reference to FIGS. 2 and 3, a function and/or an operation of the electronic device 1000 of the disclosure for removing or attenuating the target sound 101 and the harmonic components 102 of the target sound 101 in the input audio 110 will be described in detail.

In operation S210 of FIG. 2, the electronic device 1000 may obtain the first output audio 120 by using an artificial intelligence model 115 to remove the target sound 101 from the input audio 110.

Referring to operation \textcircled{1} of the embodiment illustrated in FIG. 3, the electronic device 1000 may input, to the artificial intelligence model 115, the input audio 110 and the original target sound 200 corresponding to the target sound 101. Based on the input audio 110 and the original target sound 200, the artificial intelligence model 115 may remove the target sound 101 from the input audio 110. In an embodiment of the disclosure, the artificial intelligence model 115 may include a lightweight model stored in the electronic device 1000.

The original target sound 200 may correspond to an audio sample obtained by independently playing a target sound under a particular acoustic environment (e.g., an anechoic chamber, an indoor environment, or an outdoor environment) or particular recording conditions (e.g., a fixed microphone position, a constant distance, or a fixed device setting), and collecting the resulting signal by using an actual recording device.

The electronic device 1000 may obtain an audio signal corresponding to the input audio 110. The obtained audio signal may be an analog signal. The electronic device 1000 may convert the obtained audio signal from analog to digital. The electronic device 1000 may divide the converted digital signal into short frames to facilitate time-domain processing. The resulting frames may be configured to overlap each other at a certain ratio. For example, the frames may be generated with a length of 20 ms and a frame shift of 10 ms. In this case, signal distortion that may occur at the boundaries between frames may be minimized. However, an embodiment of the disclosure is not limited thereto. The electronic device 1000 may convert the resulting frames into a spectrogram in the time-frequency domain through a fast Fourier transform (FFT). The spectrogram may include frequency information and amplitude information of an audio signal corresponding to the input audio 110.

In an embodiment of the disclosure, the electronic device 1000 may input, to the artificial intelligence model 115, the spectrogram converted from the input audio 110 and a spectrogram corresponding to the original target sound 200. Based on the input spectrogram of the original target sound 200, the artificial intelligence model 115 may estimate a region (and/or a proportion) in which the actual target sound 101 exists within the input audio 110, and may output the first output audio 120 in which the estimated target sound 101 within the input audio 110 has been removed or attenuated.

In operation S220 of FIG. 2, the electronic device 1000 may obtain residual audio 125 including the target sound 101, by using a difference between the input audio 110 and the first output audio 120. The electronic device 1000 may obtain residual audio 125 including the target sound 101, based on a difference between the input audio 110 and the first output audio 120.

Referring to operation \textcircled{2} of the embodiment illustrated in FIG. 3, the electronic device 1000 may generate the residual audio 125 by subtracting the first output audio 120 from the input audio 110.

In an embodiment of the disclosure, the electronic device 1000 may generate the residual audio 125 by using a time-domain subtraction method. That is, the electronic device 1000 may generate the residual audio 125 by subtracting the audio waveform of the first output audio 120 from the audio waveform of the input audio 110.

Alternatively, in an embodiment of the disclosure, the electronic device 1000 may generate residual audio 125 by using a frequency-domain subtraction method. That is, after converting the input audio 110 and the first output audio 120 into respective spectrograms, the electronic device 1000 may generate the residual audio 125 by subtracting complex values at each frequency-time bin. The complex values may include both amplitude information and phase information of the audio signal.

The electronic device 1000 may generate the residual audio 125 that contains only the target sound 101 isolated by the artificial intelligence model 115. Through this, the electronic device 1000 may obtain, from the residual audio 125, information about the target sound 101 in the actual recording environment.

In operation S230 of FIG. 2, the electronic device 1000 may estimate features of the target sound 101 based on the residual audio 125.

Referring to operation \textcircled{3} of the embodiment illustrated in FIG. 3, the electronic device 1000 may estimate the features of the target sound 101 based on the residual audio 125 that contains the target sound 101 isolated by the artificial intelligence model 115. The features of the target sound 101 may collectively refer to characteristics that make the corresponding sound signal distinguishable from other sounds, such as a time-domain waveform, a frequency spectrum distribution, phase characteristics, or an amplitude modulation pattern. For example, the features of the target sound 101 may correspond to a pattern representing distribution characteristics of the target sound 101 in the time-frequency domain. In this case, the features of the target sound 101 may include a temporal change for each frequency band represented in a spectrogram.

In an embodiment of the disclosure, the electronic device 1000 may obtain a pattern map 300 corresponding to the features of the target sound 101. The pattern map 300 may correspond to a map that represents the distribution of frequency components of the target sound 101 over time in the time-frequency domain. The horizontal axis (x-axis) of the pattern map 300 may represent time information, and the vertical axis (y-axis) of the pattern map 300 may represent frequency information. The size of the pattern map 300 may be determined by a time interval during which the target sound 101 occurs and a frequency interval that the target sound 101 occupies, based on the residual audio 125.

In operation S240 of FIG. 2, based on the estimated features of the target sound 101, the electronic device 1000 may search for harmonic components of the target sound 101 within the first output audio 120.

Referring to operation \textcircled{4} of the embodiment illustrated in FIG. 3, the electronic device 1000 may search for the harmonic components 102 of the target sound 101 within the first output audio 120, by using the pattern map 300 corresponding to the features of the target sound 101.

Based on the residual audio 125, the electronic device 1000 may estimate a target interval in which the target sound 101 exists within the input audio 110. The target interval may refer to a time interval, but an embodiment of the disclosure is not limited thereto, and may include not only a time interval but also a frequency interval. The electronic device 1000 may use a filter corresponding to the pattern map 300 to search for the harmonic components 102 while shifting the filter within the target interval by a defined (e.g., predefined or predetermined) frequency step.

For example, the filter corresponding to the pattern map 300 may include a pattern region where harmonic components exist and a surrounding region other than the pattern region. For each of window regions that are sequentially matched with the filter corresponding to the pattern map 300 within the target interval, the electronic device 1000 may calculate an attention score corresponding to the ratio of the average of first spectrogram magnitudes in a region matched with the pattern region to the average of second spectrogram magnitudes in a region matched with the surrounding region.

Based on the attention score of each of the window regions, the electronic device 1000 may identify (or determine), from among the window regions, a region that includes the harmonic components 102. The electronic device 1000 may determine at least one window region from among the window regions, as at least one harmonic region that includes the harmonic components 102. For example, from among the window regions, the electronic device 1000 may determine, as at least one harmonic region, at least one window region whose attention score falls within a preset top percentage.

In operation S250 of FIG. 2, the electronic device 1000 may obtain the second output audio 130 by reducing the magnitudes of the harmonic components 102 in the first output audio 120.

Referring to operation 5 of the embodiment illustrated in FIG. 3, the electronic device 1000 may reduce the magnitudes in at least one determined harmonic region within the first output audio 120.

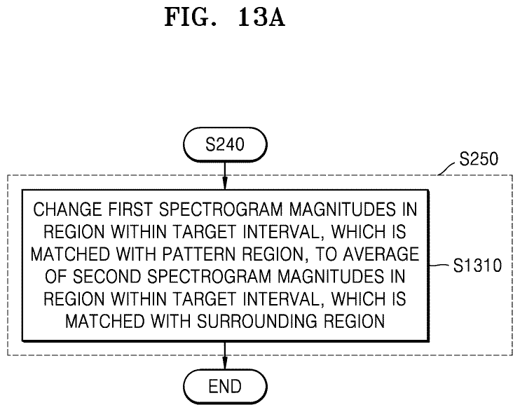

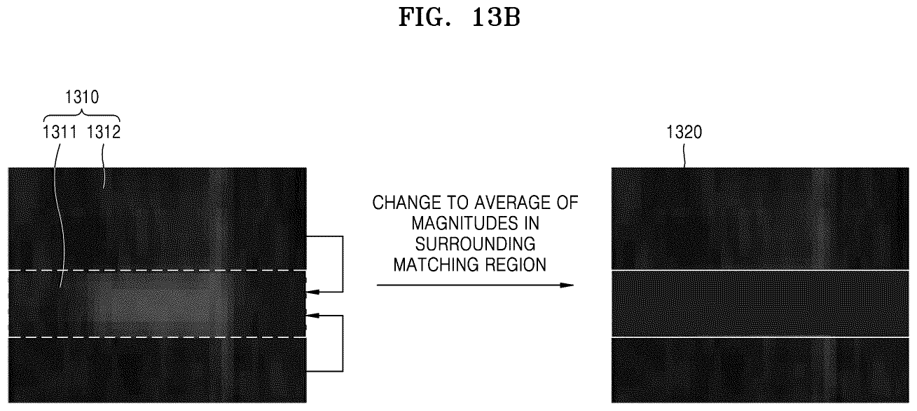

In an embodiment of the disclosure, the electronic device 1000 may change first spectrogram magnitudes to the average of second spectrogram magnitudes. That is, the electronic device 1000 may change the magnitudes in the region matched with the pattern region to the average magnitude in the region matched with the surrounding region. An operation, performed by the electronic device 1000, of changing the magnitudes in the region matched with the pattern region to the average magnitude in the region matched with the surrounding region will be described below in detail with reference to FIGS. 13A and 13B.

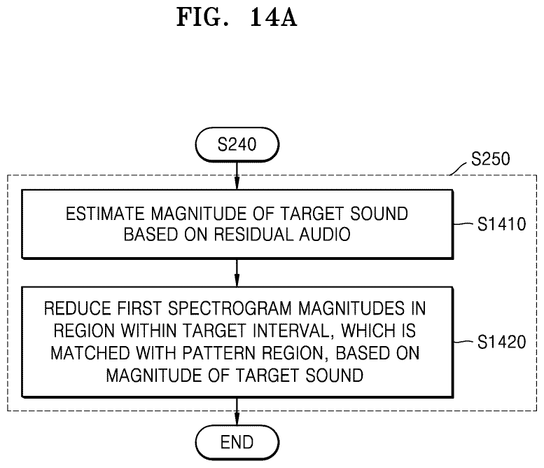

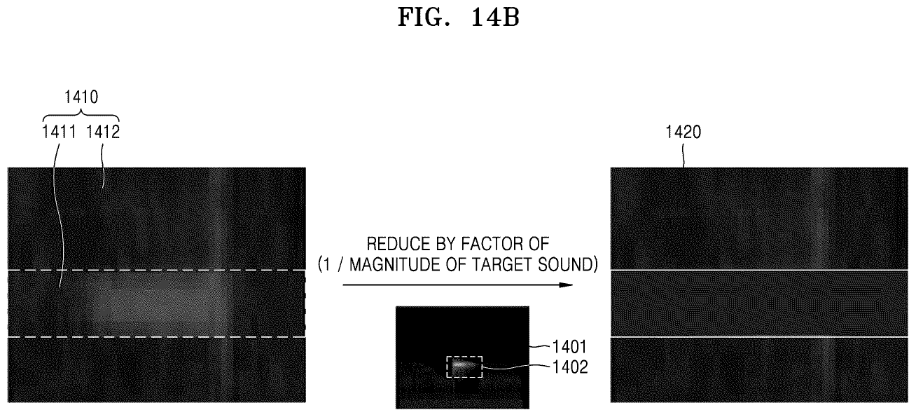

Alternatively, in an embodiment of the disclosure, the electronic device 1000 may reduce the first spectrogram magnitudes based on the magnitude of the target sound 101. For example, the electronic device 1000 may estimate the magnitude of the target sound 101 based on the residual audio 125. Based on the estimated magnitude of the target sound 101, the electronic device 1000 may reduce the magnitudes in the region matched with the pattern region. For example, the electronic device 1000 may reduce the magnitudes in the region matched with the pattern region, by a factor of (1/estimated magnitude of target sound 101). An operation, performed by the electronic device 1000, of reducing the first spectrogram magnitudes based on the magnitude of the target sound 101 will be described below in detail with reference to FIGS. 14A and 14B.

According to an embodiment of the disclosure, after removing the target sound 101 from the input audio 110 by applying the original target sound 200 and the input audio 110 to the artificial intelligence model 115, the electronic device 1000 may remove the remaining harmonic components 102 of the target sound 101. Here, by estimating the features of the target sound 101 based on the residual audio 125, the electronic device 1000 may more accurately estimate the features of the actually recorded target sound 101, even when the recording environment of the original target sound 200 and the recording (or capturing) environment of the input audio 110 are different from each other. Accordingly, based on the more accurately estimated features of the target sound 101, the electronic device 1000 may also more accurately search for the harmonic components of the target sound 101 within the input audio 110 (or the first output audio 120). By more effectively removing not only the target sound 101 but also the harmonic components 102 of the target sound 101, the electronic device 1000 may provide audio or video with improved quality, from which sounds recorded regardless of a user's intention have been removed.

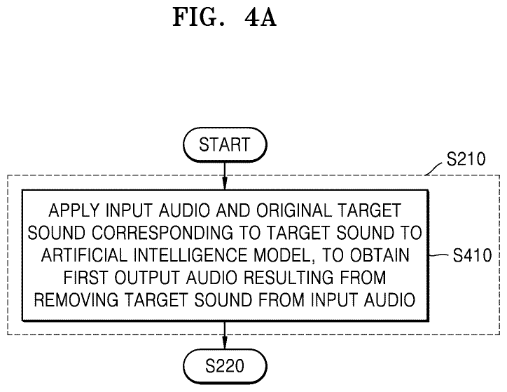

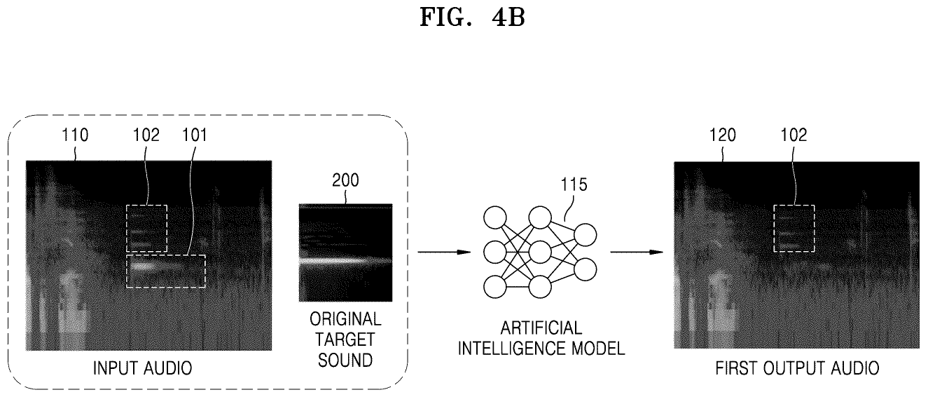

FIG. 4A is a flowchart illustrating a method, performed by the electronic device 1000, of obtaining the first output audio 120 by using the artificial intelligence model 115, according to an embodiment of the disclosure. FIG. 4B is a diagram illustrating an operation, performed by the electronic device 1000, of obtaining the first output audio 120 by using the artificial intelligence model 115, according to an embodiment of the disclosure.

Operation S410 of FIG. 4A represents a detailed implementation of operation S210 of FIG. 2. In an embodiment of the disclosure, operation S410 may be performed by at least one processor 1920 (see FIG. 19) included in the electronic device 1000. After operation S410 of FIG. 4A is performed, operation S220 of FIG. 2 may be performed.

In operation S410 of FIG. 4A, according to an embodiment of the disclosure, the electronic device 1000 may apply the input audio 110 and the original target sound 200 corresponding to the target sound 101 to the artificial intelligence model 115, to obtain the first output audio 120 resulting from removing the target sound 101 from the input audio 110.

Referring to FIG. 4B, in an embodiment of the disclosure, the electronic device 1000 may input the input audio 110 and the original target sound 200 to the artificial intelligence model 115. For example, the electronic device 1000 may input a spectrogram of the input audio 110 and a spectrogram of the original target sound 200 to the artificial intelligence model 115. Based on the original target sound 200, the artificial intelligence model 115 may output the first output audio 120 resulting from removing or attenuating the target sound 101 from the input audio 110. For example, the artificial intelligence model 115 may output a spectrogram of the first output audio 120.

The electronic device 1000 may obtain the first output audio 120 resulting from removing or attenuating the target sound 101 from the input audio 110, by using the artificial intelligence model 115. For example, the electronic device 1000 may obtain a spectrogram of the first output audio 120 by using the artificial intelligence model 115.

According to an embodiment of the disclosure, the artificial intelligence model 115 may be stored (or installed) in the electronic device 1000, and in this case, the artificial intelligence model 115 may be a lightweight model for removing the target sound 101. The harmonic components 102 of the target sound 101 are components derived from the target sound 101, and the lightweight model may fail to recognize, as removal targets, the harmonic components 102 of the target sound 101 in the input audio 110. Accordingly, the harmonic components 102 of the target sound 101 may remain in the first output audio 120 that is output by the lightweight model.

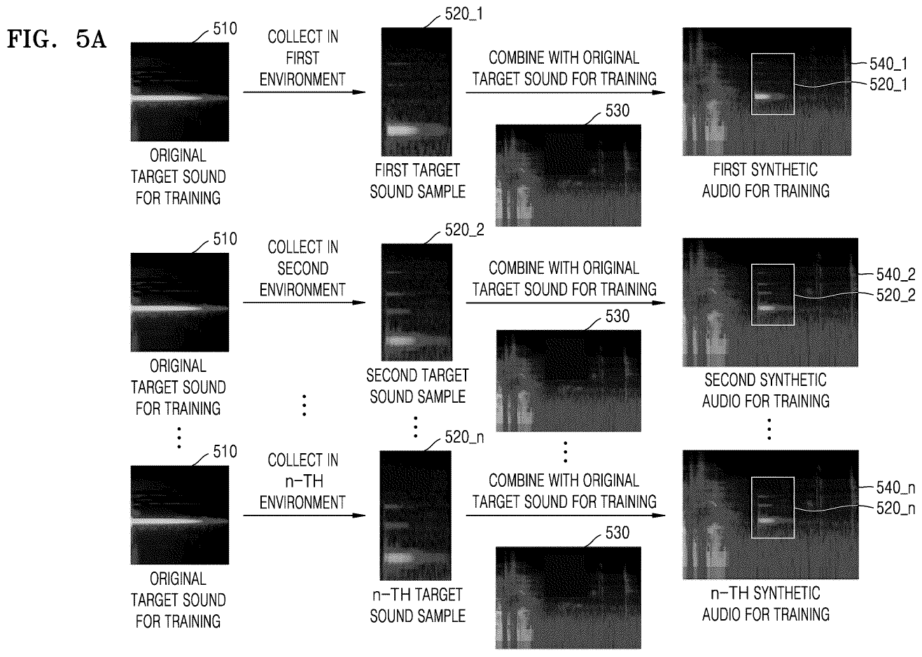

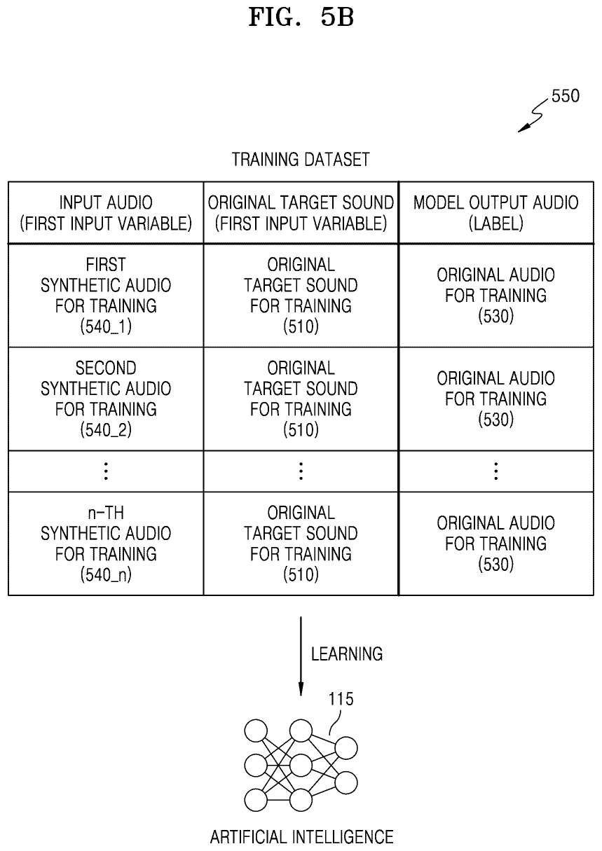

FIG. 5A is a diagram illustrating a method of generating a training dataset for the artificial intelligence model 115, according to an embodiment of the disclosure. FIG. 5B is a diagram illustrating an operation of performing pre-training of the artificial intelligence model 115, according to an embodiment of the disclosure.

Referring to FIG. 5A, in an embodiment of the disclosure, the artificial intelligence model 115 may be a pre-trained model. The artificial intelligence model 115 may be a model that has been pre-trained by using a training dataset. In an embodiment of the disclosure, the training dataset may include an original target sound 510 for training, original audio 530 for training, and a plurality of pieces of synthetic audio 540_1 to 540_n for training.

The plurality of pieces of synthetic audio 540_1 to 540_n for training may be generated based on a plurality of target sound samples 520_1 to 520_n and the original audio 530 for training. The plurality of target sound samples 520_1 to 520_n may be audio data obtained by collecting (e.g., recording) a target sound under various environmental conditions. For example, the plurality of target sound samples 520_1 to 520_n may include a first target sound sample 520_1 obtained by collecting the target sound in a first environment, a second target sound sample 520_2 obtained by collecting the target sound in a second environment, . . . , and an n-th target sound sample 520_n obtained by collecting the target sound in an n-th environment. The first environment, the second environment, . . . , and the n-th environment may be different environments. For example, the different environments may include an indoor environment, an outdoor environment, a quiet environment, a noisy environment, a highly reverberant environment, and an environment in which a sound is played by various playback devices, but an embodiment of the disclosure is not limited thereto.

The plurality of pieces of synthetic audio 540_1 to 540_n for training may be data obtained by combining the plurality of target sound samples 520_1 to 520_n with the original audio 530 for training, which does not include the target sound. For example, the original audio 530 for training may refer to an audio signal obtained in a state in which the target sound is not played while ambient environmental sounds are collected (e.g., recorded). For example, the plurality of pieces of synthetic audio 540_1 to 540_n for training may include first synthetic audio 540_1 for training obtained by combining the first target sound sample 520_1 with the original audio 530 for training, second synthetic audio 540_2 for training obtained by combining the second target sound sample 520_2 with the original audio 530 for training, . . . , and n-th synthetic audio 540_n for training obtained by combining the n-th target sound sample 520_n with the original audio 530 for training.

Referring to FIG. 5B, a training dataset 550 may be constructed for pre-training of the artificial intelligence model 115. The training dataset 550 may be composed of input variables and labels. The labels may correspond to ground-truth data for the input variables. For example, the plurality of pieces of synthetic audio 540_1 to 540_n for training, including the first to n-th pieces of synthetic audio 540_1 to 540_n for training, may be set as first input variables. The original target sound 510 for training may be set as a second input variable. The original audio 530 for training may be set as a label. The training dataset 550 may be constructed based on a combination of the first input variables, the second input variable, and the label.

The artificial intelligence model 115 may be a model that is pre-trained based on the training dataset 550. Here, the pre-training process may include optimizing parameters such that the artificial intelligence model 115 learns a mapping relationship between the input variables (e.g., the first input variables and the second input variable) and the label.

For example, the first input variable and the second input variable may be delivered to an input layer of the artificial intelligence model 115. The artificial intelligence model 115 may calculate a predicted value based on the first input variable and the second input variable, and optimize the performance of the artificial intelligence model 115 by repeatedly updating weight and bias parameters of the artificial intelligence model 115 such that an error between the calculated predicted value and the label is minimized. Through this, the artificial intelligence model 115 may learn the relationship between the original target sound and the target sound in the actual collection environment.

Accordingly, the artificial intelligence model 115 may be trained to, based on input audio from an actual collection environment, and a target sound sample resulting from collecting only a target sound (e.g., an original target sound), output audio resulting from removing the target sound from the input audio (i.e., first output audio).

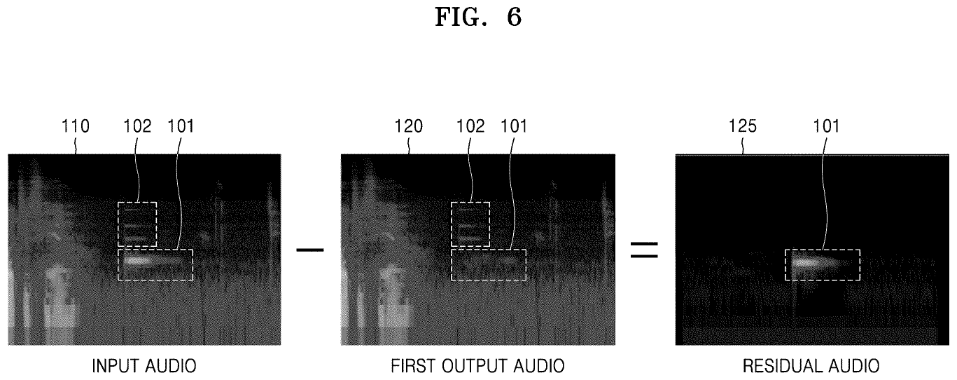

FIG. 6 is a diagram illustrating a method, performed by the electronic device 1000, of obtaining the residual audio 125, according to an embodiment of the disclosure.

Referring to FIG. 6, in an embodiment of the disclosure, the electronic device 1000 may obtain the residual audio 125 by removing the first output audio 120 from the input audio 110. The first output audio 120 may be audio resulting from removing or attenuating the target sound 101, which is predicted by the artificial intelligence model 115, from the input audio 110. By removing the first output audio 120 from the input audio 110 to obtain the residual audio 125, the electronic device 1000 may obtain the distribution of a spectrogram for the target sound 101 predicted by the artificial intelligence model 115.

In an embodiment of the disclosure, the harmonic components 102 of the target sound 101 may remain in the first output audio 120 without being removed, because the artificial intelligence model 115 fails to predict the harmonic components 102 of the target sound 101 within input audio 110. The harmonic components 102 of the target sound 101 may be difficult to remove by using the artificial intelligence model 115 because they are distributed in frequency bands different from the frequency band of the target sound 101.

The distribution of the spectrogram for the target sound 101 in the actual recording environment may be slightly different from the distribution of a spectrogram for the original target sound 200. That is, the distribution of the spectrogram for the target sound 101 in the input audio 110 may be slightly different from the distribution of the spectrogram for the original target sound 200. According to an embodiment of the disclosure, by obtaining the residual audio 125, the electronic device 1000 may obtain the distribution of the spectrogram for the target sound 101 within the input audio 110 in the actual recording environment. Through this, based on the distribution of the spectrogram for the target sound 101 in the actual recording environment, the electronic device 1000 may estimate the features of the target sound 101 that was actually recorded in the input audio 110.

The features of the harmonic components 102 of the target sound 101 may be similar to the features of the target sound 101. According to an embodiment of the disclosure, as the features of the target sound 101 in the actual recording environment are estimated based on the residual audio 125, it is possible to more accurately search for the harmonic components 102 having features similar to the features of the actually recorded target sound 101 within the first output audio 120 (or the input audio 110).

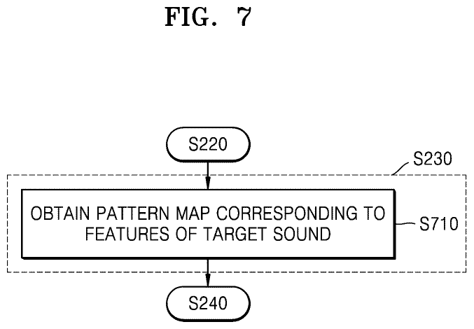

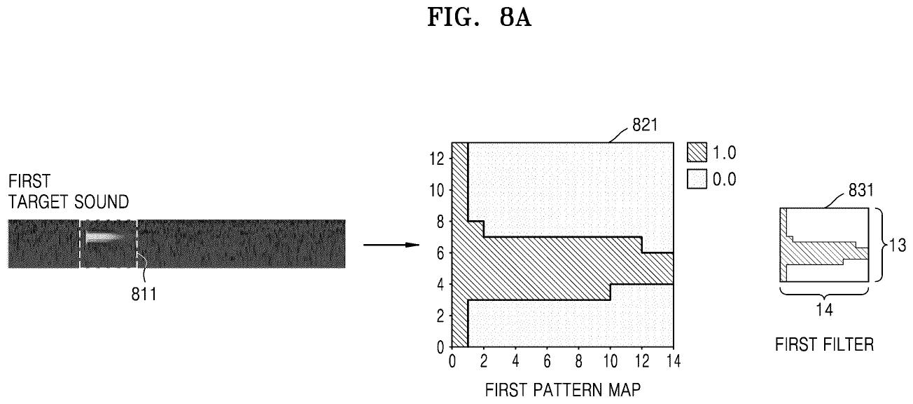

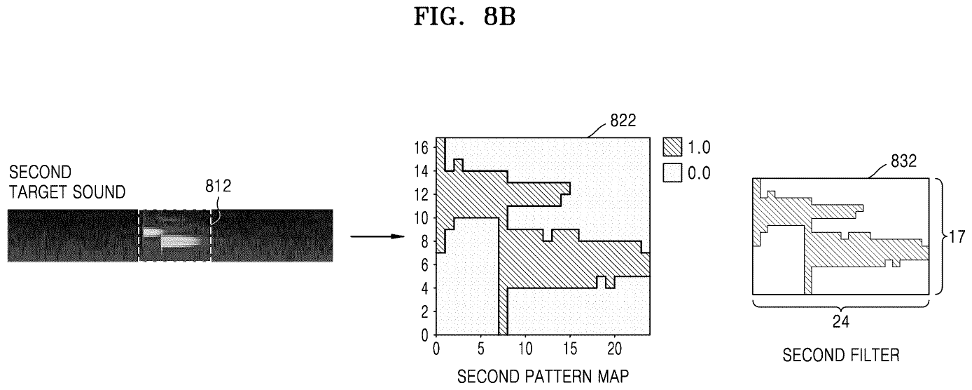

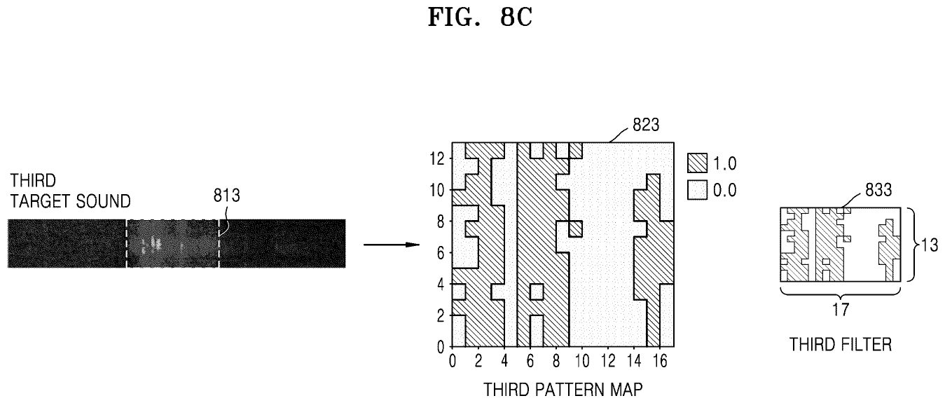

FIG. 7 is a flowchart illustrating a method, performed by the electronic device 1000, of estimating features of a target sound, according to an embodiment of the disclosure. FIG. 8A is a diagram illustrating an operation, performed by the electronic device 1000, of estimating features of a target sound 811, according to an embodiment of the disclosure. FIG. 8B is a diagram illustrating an operation, performed by the electronic device 1000, of estimating features of a target sound 812, according to an embodiment of the disclosure. FIG. 8C is a diagram illustrating an operation, performed by the electronic device 1000, of estimating features of a target sound 813, according to an embodiment of the disclosure.

Operation S710 of FIG. 7 represents a detailed implementation of operation S230 of FIG. 2. In an embodiment of the disclosure, operation S710 may be performed by at least one processor 1920 (see FIG. 19) included in the electronic device 1000. Operation S710 of FIG. 7 may be performed after operation S220 of FIG. 2 is performed. After operation S710 of FIG. 7 is performed, operation S240 of FIG. 2 may be performed.

In operation S710 of FIG. 7, according to an embodiment of the disclosure, the electronic device 1000 may obtain a pattern map corresponding to the features of the target sound 101. The electronic device 1000 may estimate the features of the target sound 101 within the input audio 110, based on the residual audio 125 obtained by removing the first output audio 120 from the input audio 110. For example, the electronic device 1000 may generate a pattern map corresponding to the features of the target sound 101 that are estimated based on the residual audio 125.

Referring to FIGS. 8A to 8C, in an embodiment of the disclosure, pattern maps 821, 822, and 823 may correspond to maps that represent distributions of frequency components of the target sounds 811, 812, and 813 over time in the time-frequency domain, respectively. The horizontal axis (x-axis) of the pattern maps 821, 822, and 823 may represent time information. The vertical axis (y-axis) of the pattern maps 821, 822, and 823 may represent frequency information. The unit of the time axis and the unit of the frequency axis, represented by the horizontal and vertical axes of the pattern maps 821, 822, and 823, may vary depending on parameters set in a process of performing an FFT. For example, the unit interval of the time axis may vary depending on a hop size of a window frame, a sampling frequency, or the like. For example, the unit interval of the frequency axis may vary depending on a sampling frequency, the number of FFT points, or the like.

In an embodiment of the disclosure, the size of a single cell determined by the unit interval of the time axis and the unit interval of the frequency axis in the pattern maps 821, 822, and 823 may correspond to the size of a time-frequency bin in a spectrogram. A cell in the pattern maps 821, 822, and 823 may refer to a minimum interval on the pattern maps, which is determined by the unit interval of the time axis and the unit interval of the frequency axis. However, an embodiment of the disclosure is not limited thereto, and the size of a cell in the pattern maps 821, 822, and 823 may be set differently from the size of a time-frequency bin in the spectrogram.

In an embodiment of the disclosure, each cell of the pattern maps 821, 822, and 823 may be recorded with a binary value indicating whether a sound signal exists in the corresponding time interval and the corresponding frequency band. For example, in each cell of the pattern maps 821, 822, and 823, the value of the corresponding cell may be set to 1 (corresponding to the light shading in FIGS. 8A to 8C) when the energy of the sound signal is greater than or equal to a predefined threshold, and may be set to 0 (corresponding to the dark shading in FIGS. 8A to 8C) when the energy of the sound signal is less than the predefined threshold.

The cells marked with ‘1’ in the pattern maps 821, 822, and 823 may indicate that the target sounds 811, 812, and 813 exist in the corresponding time-frequency intervals. The temporal/spatial distribution of the cells marked with ‘l’ in the pattern maps 821, 822, and 823 may form a pattern of a particular shape. Through this, the electronic device 1000 may estimate features of the target sounds 811, 812, and 813, based on the pattern maps 821, 822, and 823, respectively. The features of the target sounds 811, 812, and 813 may refer to characteristics in the time-frequency domain that may distinguish the target sounds 811, 812, and 813 from other sounds. For example, the features of the target sounds 811, 812, and 813 may include a temporal change pattern of a particular frequency band. The features of the target sounds 811, 812, and 813 may include an aspect of temporal change in the frequency distribution, such as a pattern in which a particular frequency band appears or disappears along the time axis.

In an embodiment of the disclosure, the electronic device 1000 may search for regions in the spectrogram of the first output audio 120 where the target sounds 811, 812, and 813 exist, based on the features of the target sounds 811, 812, and 813 estimated through the pattern maps 821, 822, and 823, respectively. For example, the electronic device 1000 may search for the regions in the spectrogram of the first output audio 120 where the target sounds 811, 812, and 813 exist, by using filters 831, 832, and 833 corresponding to the pattern maps 821, 822, and 823, respectively. The filters 831, 832, and 833 corresponding to the pattern maps 821, 822, and 823 may be implemented to perform a matching operation between comparison targets based on patterns that are based on the temporal-spatial distribution on the pattern maps 821, 822, and 823. For example, the filters 831, 832, and 833 may each be implemented as a two-dimensional coefficient matrix.

In an embodiment of the disclosure, the sizes of the filters 831, 832, and 833 may be set based on the pattern maps 821, 822, and 823, respectively. For example, the filters 831, 832, and 833 may be configured to have the same dimensions as the number of rows and columns of the pattern maps 821, 822, and 823, respectively, thereby enabling the elements of the filters 831, 832, and 833 to be mapped on a one-to-one basis to the cells of the pattern maps 821, 822, and 823 for performing operations, respectively. As the filters 831, 832, and 833 are determined based on the cell arrangement of the pattern maps 821, 822, and 823, respectively, a matching operation may be performed based on the features of the target sounds 811, 812, and 813 in the pattern maps 821, 822, and 823 by using the filters 831, 832, and 833, respectively.

FIG. 8A exemplarily illustrates the first target sound 811 corresponding to a video recording start sound, and the first pattern map 821 and the first filter 831 corresponding to the first target sound 811. The video recording start sound is a signal sound that is played at the time when recording starts, to notify the user that the recording has started. For example, the video recording start sound may be a sound that is played when the user presses a record button. Alternatively, for example, the video recording start sound may be a sound that is played when the device automatically starts video recording (e.g., scheduled recording, sensor detection, or an event trigger).

FIG. 8A exemplarily illustrates that the first target sound 811 corresponding to the video recording start sound is implemented as a single beep-like sound, but an embodiment of the disclosure is not limited thereto.

The time range of the first pattern map 821 may be determined by the time interval during which the first target sound 811 occurs within the spectrogram including the first target sound 811, and the frequency range of the first pattern map 821 may be determined by the frequency interval that the first target sound 811 occupies within the spectrogram including the first target sound 811. The size of the first filter 831 may be determined corresponding to the time range and the frequency range of the first pattern map 821.

FIG. 8B exemplarily illustrates the second target sound 812 corresponding to a video recording end sound, and the second pattern map 822 and the second filter 832 corresponding to the second target sound 812. The video recording end sound is a signal sound that is played when recording is stopped or ended, to notify the user that the recording has ended. For example, the video recording end sound may be a sound that is played when the user presses a stop recording button or an end recording button. Alternatively, for example, the video recording end sound may be a sound that is played when the device automatically stops or ends video recording (e.g., scheduled recording, sensor detection, or an event trigger).

FIG. 8B exemplarily illustrates that the second target sound 812 corresponding to the video recording end sound is implemented as a sound having two short, consecutive tones or a melody (e.g., two descending notes), but an embodiment of the disclosure is not limited thereto.

The time range of the second pattern map 822 may be determined by the time interval during which the second target sound 812 occurs within the spectrogram including the second target sound 812, and the frequency range of the second pattern map 822 may be determined by the frequency interval that the second target sound 812 occupies within the spectrogram including the second target sound 812. The size of the second filter 832 may be determined corresponding to the time range and the frequency range of the second pattern map 822.

FIG. 8C exemplarily illustrates the third target sound 813 corresponding to a camera shutter sound, and the third pattern map 823 and the third filter 833 corresponding to the third target sound 813. The camera shutter sound is a signal sound that is played when capturing a still image, to notify the user of the capture timing. For example, the camera shutter sound may be a sound that is played when the user presses a capture button. Alternatively, for example, the camera shutter sound may be a sound that is played when the device automatically captures a still image (e.g., scheduled capture, sensor detection, or an event trigger).

FIG. 8C exemplarily illustrates that the third target sound 813 corresponding to the camera shutter sound is implemented as a shutter sound having relatively wideband frequency components, but an embodiment of the disclosure is not limited thereto.

The time range of the third pattern map 823 may be determined by the time interval during which the third target sound 813 occurs within the spectrogram including the third target sound 813, and the frequency range of the third pattern map 823 may be determined by the frequency interval that the third target sound 813 occupies within the spectrogram including the third target sound 813. The size of the third filter 833 may be determined corresponding to the time range and the frequency range of the third pattern map 823.

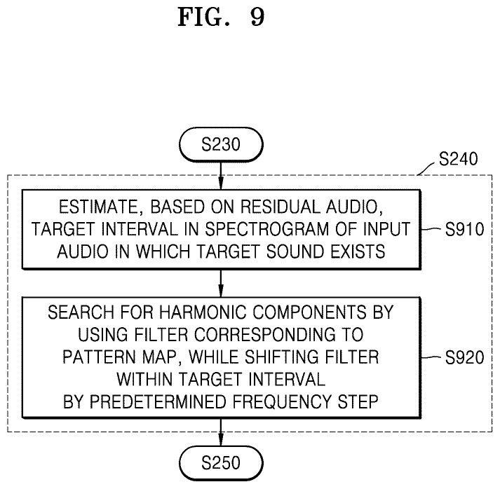

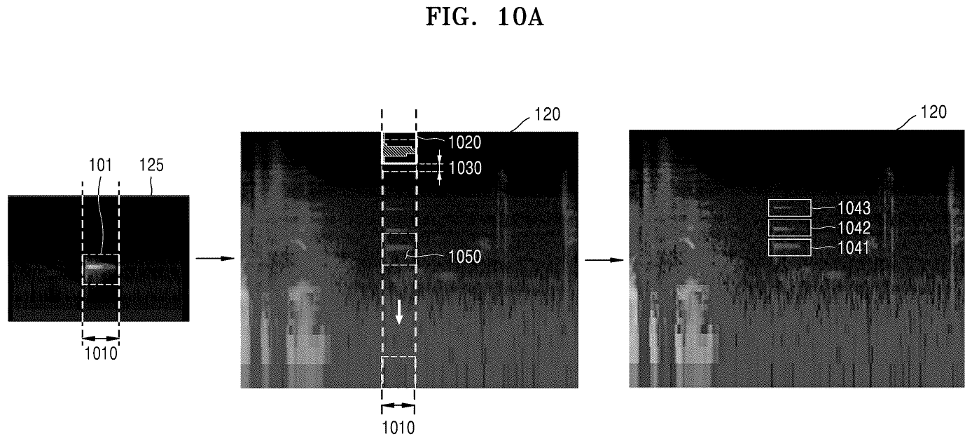

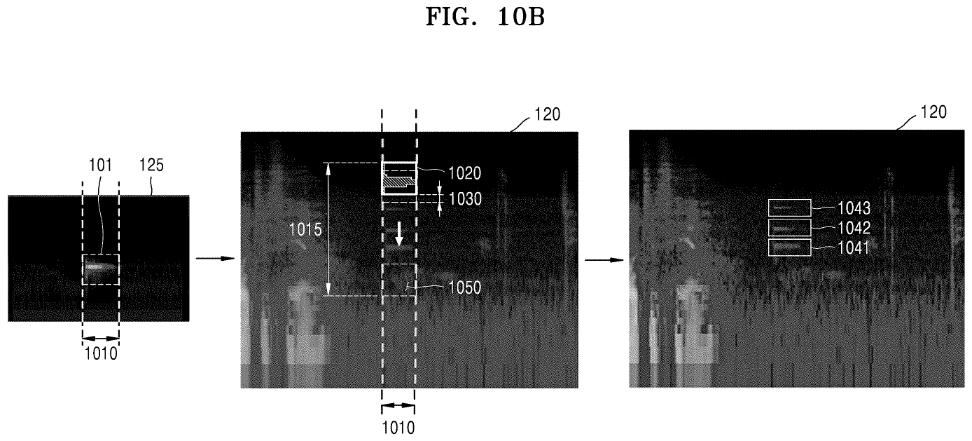

FIG. 9 is a flowchart illustrating a method, performed by the electronic device 1000, of searching for harmonic components within the first output audio 120, according to an embodiment of the disclosure. FIG. 10A is a diagram illustrating an operation, performed by the electronic device 1000, of searching for harmonic components within the first output audio 120, according to an embodiment of the disclosure. FIG. 10B is a diagram illustrating an operation, performed by the electronic device 1000, of searching for harmonic components within the first output audio 120, according to an embodiment of the disclosure.

Operations S910 and S920 of FIG. 9 represent a detailed implementation of operation S240 of FIG. 2. In an embodiment of the disclosure, operations S910 and S920 may be performed by at least one processor 1920 (see FIG. 19) included in the electronic device 1000. Operation S910 of FIG. 9 may be performed after operation S230 of FIG. 2 is performed. After operation S920 of FIG. 9 is performed, operation S250 of FIG. 2 may be performed.

In operation S910 of FIG. 9, according to an embodiment of the disclosure, the electronic device 1000 may estimate, based on the residual audio 125, a target interval in the spectrogram of the input audio 110 in which the target sound 101 exists.

Referring to FIGS. 10A and 10B, in an embodiment of the disclosure, the electronic device 1000 may determine a target interval 1010 based on the time interval in which the target sound 101 is estimated to exist within the input audio 110. For example, the target interval 1010 may be determined as the time interval in which the target sound 101 exists within the residual audio 125. However, an embodiment of the disclosure is not limited thereto, and the target interval 1010 may be determined to include extra time periods before and/or after the time interval in which the target sound 101 is estimated to exist. For example, the target interval 1010 may be set as an interval from a time point that precedes the start of the target sound 101 by a defined (e.g., predefined or predetermined) amount of time, to a time point that follows the end of the target sound 101 by a defined (e.g., predefined or predetermined) amount of time.

FIGS. 10A and 10B show the target interval 1010, which is determined based on the residual audio 125, within the first output audio 120. FIGS. 10A and 10B exemplarily illustrates that the target interval 1010 is determined to be identical to the time interval in which the target sound 101 exists within the residual audio 125.

In operation S920 of FIG. 9, according to an embodiment of the disclosure, the electronic device 1000 may search for harmonic components by using a filter 1020 corresponding to a pattern map, while shifting the filter 1020 within the target interval 1010 by a defined (e.g., predefined or predetermined) frequency step 1030. The filter 1020 corresponding to the pattern map may be implemented to perform a matching operation between comparison targets based on a pattern that is based on the temporal-spatial distribution on the pattern map. For example, the filter 1020 corresponding to the pattern map may have a structure in which the elements of the filter 1020 are mapped on a one-to-one basis to the cells of the pattern map. For example, the filter 1020 may be implemented as a two-dimensional coefficient matrix.

Referring to FIG. 10A, in an embodiment of the disclosure, the electronic device 1000 may sequentially search through all frequency bands within the target interval 1010 by using the filter 1020. For example, the electronic device 1000 may sequentially search the target interval 1010 while shifting the filter 1020 within the target interval 1010 from an upper-limit frequency (or a maximum frequency) to a lower-limit frequency (or a minimum frequency) by the defined (e.g., predefined or predetermined) frequency step 1030. Alternatively, for example, the electronic device 1000 may sequentially search the target interval 1010 while shifting the filter 1020 within the target interval 1010 from a lower-limit frequency (or a minimum frequency) to an upper-limit frequency (or a maximum frequency) by the defined (e.g., predefined or predetermined) frequency step 1030.

Referring to FIG. 10B, in an embodiment of the disclosure, the electronic device 1000 may sequentially search only a partial frequency band 1015 within the target interval 1010 by using the filter 1020. For example, the electronic device 1000 may search only the partial frequency band 1015 at or above the frequency band of the target sound 101, but the scope of the partial frequency band 1015 is not limited thereto.

Referring to FIGS. 10A and 10B, in an embodiment of the disclosure, as the structure of the filter 1020 is determined based on the cell arrangement of the pattern map, the electronic device 1000 may perform a matching operation in the target interval 1010 based on the features of the target sound 101 in the pattern map by using the filter 1020. The electronic device 1000 may perform the matching operation while shifting the filter 1020 within the target interval 1010 from an upper-limit frequency to a lower-limit frequency by the defined (e.g., predefined or predetermined) frequency step 1030. Based on a result of the matching operation, the electronic device 1000 may determine (or identify) whether harmonic components of the target sound 101 exist in an interval (or a region) matched with the filter 1020 within the target interval 1010.

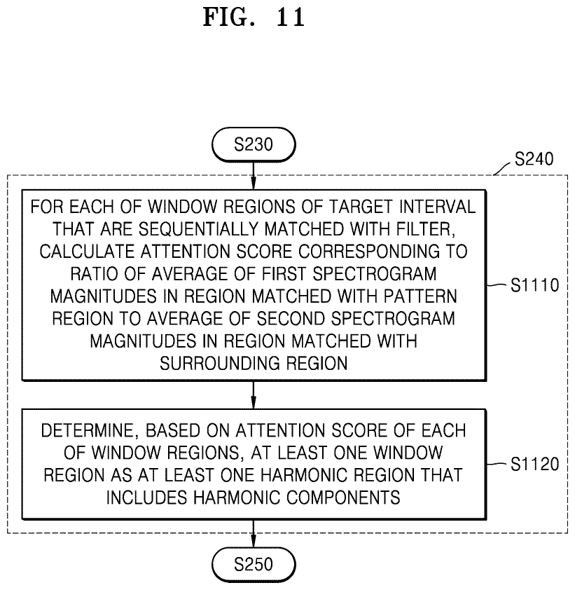

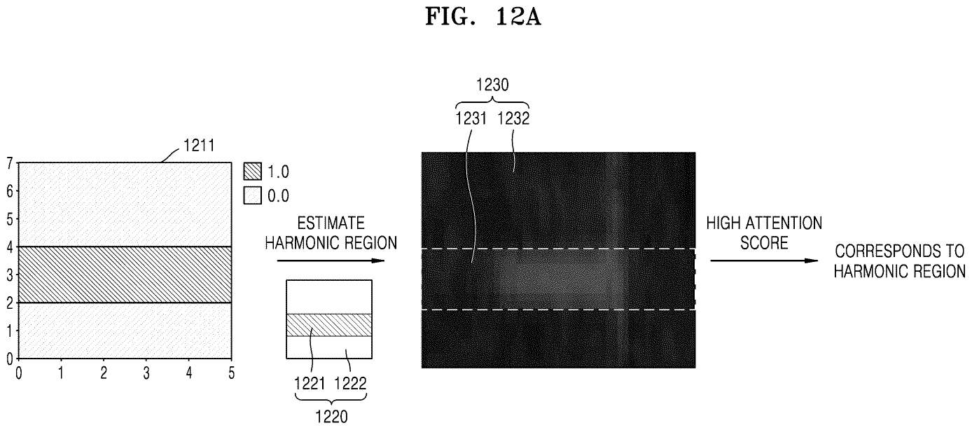

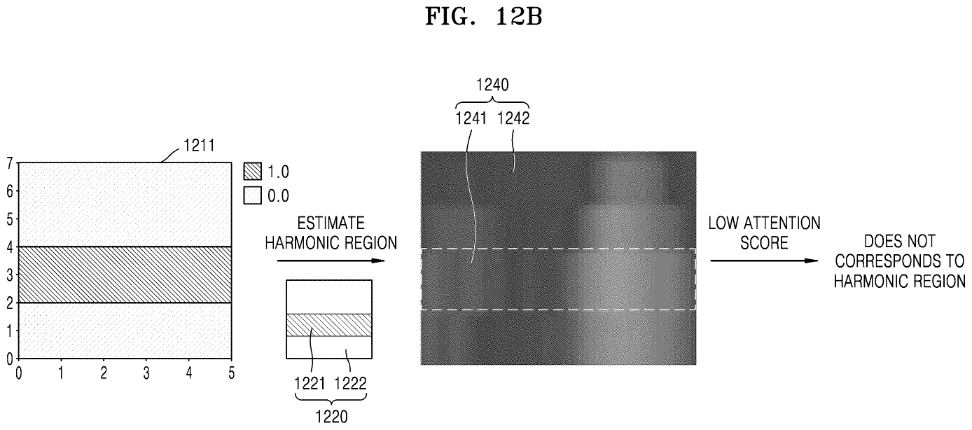

Regions within the target interval 1010 that are sequentially matched with the filter 1020 may be defined as window regions 1050. The electronic device 1000 may match a pattern of the spectrogram in each window region 1050 with the filter 1020. Based on the degree of matching between each window region 1050 and the filter 1020, the electronic device 1000 may determine (or identify or discriminate) the presence or absence of harmonic components of the target sound 101. A method of determining the presence or absence of harmonic components of the target sound 101 will be described below with reference to FIGS. 11 to 12B. FIGS. 10A and 10B exemplarily illustrates that three harmonic components 1041, 1042, and 1043 have been found within the target interval 1010 of the first output audio 120.

According to an embodiment of the disclosure, the electronic device 1000 may search for the harmonic components 1041, 1042, and 1043 of the target sound 101 within the first output audio 120 by using the filter 1020 corresponding to a pattern map that reflects the features of the actually recorded target sound. As the harmonic components 1041, 1042, and 1043 of the target sound 101 are similar to the features of the target sound 101, the harmonic components 1041, 1042, and 1043 of the target sound 101 may be more accurately detected within the first output audio 120.

Although FIGS. 10A and 10B exemplarily illustrates that the target interval 1010 has the same temporal length as that of the filter 1020, an embodiment of the disclosure is not limited thereto. For example, when the target interval 1010 is determined to include extra time periods before and/or after the time interval in which the target sound 101 is estimated to exist, the target interval 1010 may be longer than the temporal length of the filter 1020. In this case, the electronic device 1000 may search for the harmonic components 1041, 1042, and 1043 by using the filter 1020 corresponding to the pattern map while shifting the filter 1020 within the target interval 1010 by the defined (e.g., predefined or predetermined) frequency step 1030 (i.e., shifting in the y-axis) and simultaneously by a defined (e.g., predefined or predetermined) time step (i.e., also shifting in the x-axis).

According to an embodiment of the disclosure, because the electronic device 1000 determines the target interval 1010 based on the time interval in which the target sound 101 is estimated to exist, and searches for the harmonic components 1041, 1042, and 1043 of the target sound 101 only within the target interval 1010, it is possible to prevent audio signals other than the target sound 101 (e.g., a voice, a background sound, or ambient noise) from being removed or attenuated.

FIG. 11 is a flowchart illustrating a method, performed by the electronic device 1000, of determining a harmonic region within first output audio, according to an embodiment of the disclosure. FIG. 12A is a diagram illustrating an operation, performed by the electronic device 1000, of determining a harmonic region within first output audio, according to an embodiment of the disclosure. FIG. 12B is a diagram illustrating an operation, performed by the electronic device 1000, of determining a harmonic region within first output audio, according to an embodiment of the disclosure.

Operations S1110 and S1120 of FIG. 11 represent a detailed implementation of operation S240 of FIG. 2. In an embodiment of the disclosure, operations S1110 and S1120 may be performed by at least one processor 1920 (see FIG. 19) included in the electronic device 1000. Operation S1110 of FIG. 11 may be performed after operation S230 of FIG. 2 is performed. After operation S1120 of FIG. 11 is performed, operation S250 of FIG. 2 may be performed.

In operation S1110 of FIG. 11, according to an embodiment of the disclosure, for each of window regions of a target interval that are sequentially matched with a filter, the electronic device 1000 may calculate an attention score corresponding to the ratio of the average of first spectrogram magnitudes in a region matched with a pattern region to the average of second spectrogram magnitudes in a region matched with a surrounding region.

Referring to FIGS. 12A and 12B, in an embodiment of the disclosure, a filter 1220 corresponding to a pattern map 1211 may include a pattern region 1221 and a surrounding region 1222. The pattern region 1221 may be a region where harmonic components exist. The pattern region 1221 may correspond to a region within the pattern map 1211 that is estimated (or determined or identified) to contain a target sound. The surrounding region 1222 may be the remaining area within the filter 1220, excluding the pattern region 1221. The surrounding region 1222 may correspond to a region within the pattern map 1211 that is estimated (or determined or identified) not to contain the target sound.

In an embodiment of the disclosure, the electronic device 1000 may calculate an attention score for each of the window regions that are sequentially matched with the filter 1220. The attention score may be calculated through Equation 1 below.

$$Attention score = \frac{Average of first spectrogram magnitudes}{Average of second spectrogram magnitudes} \qquad [ Equation 1 ]$$

Here, the average of the first spectrogram magnitudes refers to the average of the spectrogram magnitudes in a region 1231 or 1241 (or referred to as the pattern matching region 1231 or 1241) within the window region, which is matched with the pattern region 1221 of the filter 1220. The average of the second spectrogram magnitudes refers to the average of the spectrogram magnitudes in a region 1232 or 1242 (or referred to as the surrounding matching region 1232 or 1242) within the window region, which is matched with the surrounding region 1222 of the filter 1220.

FIGS. 12A and 12B exemplarily illustrate window regions 1230 and 1240 that are matched with the filter 1220.

As illustrated in FIG. 12A, it may be seen that the average of the spectrogram magnitudes in the region 1231 (i.e., the pattern matching region 1231) matched with the pattern region 1221 is greater than the average of the spectrogram magnitudes in the region 1232 (i.e., the surrounding matching region 1232) matched with the surrounding region 1222. Accordingly, the attention score of the window region 1230 illustrated in FIG. 12A may be relatively high.

As illustrated in FIG. 12B, it may be seen that the average of the spectrogram magnitudes in the region 1241 (i.e., the pattern matching region 1241) matched with the pattern region 1221 and the average of the spectrogram magnitudes in the region 1242 (i.e., the surrounding matching region 1242) matched with the surrounding region 1222 are similar to each other. In the window region 1240 illustrated in FIG. 12B, because the spectrogram magnitudes in the region 1241 matched with the pattern region and the spectrogram magnitudes in the region 1242 matched with the surrounding region are high, the attention score of the window region 1240 illustrated in FIG. 12B may be relatively low.

In operation S1120 of FIG. 11, according to an embodiment of the disclosure, the electronic device 1000 may determine, based on the attention score of each of the window regions, at least one window region as at least one harmonic region that includes harmonic components.

In an embodiment of the disclosure, based on the attention scores of the window regions, the electronic device 1000 may determine, as one or more harmonic regions, one or more window regions whose attention scores fall within a preset top percentage (e.g., a preset top percentage range).

Alternatively, in an embodiment of the disclosure, based on whether the attention score of each window region is greater than or equal to a preset threshold score, the electronic device 1000 may determine, as one or more harmonic regions, one or more window regions whose attention scores are greater than or equal to the preset threshold score.

For example, based on the attention score of the window region 1230 illustrated in FIG. 12A being relatively high, the electronic device 1000 may determine, as a harmonic region, the region 1231 in the window region 1230 illustrated in FIG. 12A, which is matched with the pattern region 1221. In other words, the electronic device 1000 may determine that harmonic components are included in the region 1231 in the window region illustrated in FIG. 12A, which is matched with the pattern region 1221.

For example, based on the attention score of the window region 1240 illustrated in FIG. 12B being relatively low, the electronic device 1000 may determine that the window region 1240 illustrated in FIG. 12B does not include a harmonic region. In other words, the electronic device 1000 may determine that the window region 1240 illustrated in FIG. 12B does not include harmonic components.

FIG. 13A is a flowchart illustrating a method, performed by the electronic device 1000, of obtaining second output audio in which magnitudes of harmonic components have been reduced, according to an embodiment of the disclosure. FIG. 13B is a diagram illustrating an operation, performed by the electronic device 1000, of obtaining second output audio 1320 in which magnitudes of harmonic components have been reduced, according to an embodiment of the disclosure.

Operation S1310 of FIG. 13A represents a detailed implementation of operation S250 of FIG. 2. In an embodiment of the disclosure, operation S1310 may be performed by at least one processor 1920 (see FIG. 19) included in the electronic device 1000. Operation S1310 of FIG. 13A may be performed after operation S240 of FIG. 2 is performed.

In operation S1310 of FIG. 13A, according to an embodiment of the disclosure, the electronic device 1000 may change first spectrogram magnitudes in a region within a target interval, which is matched with a pattern region, to the average of second spectrogram magnitudes in a region within the target interval, which is matched with a surrounding region.

FIG. 13B exemplarily illustrates a window region 1310 that is determined as a harmonic region because its attention score is greater than or equal to a preset threshold score. Hereinafter, the window region 1310 of FIG. 13B will be referred to as a harmonic region 1310. Referring to FIG. 13B, in an embodiment of the disclosure, the harmonic region 1310 may include a region 1311 matched with the pattern region of the filter (also referred to as a pattern matching region 1311) and a region 1312 matched with the surrounding region of the filter (also referred to as a surrounding matching region 1312).

In an embodiment of the disclosure, the electronic device 1000 may obtain information about a second spectrogram magnitude, which is the average of spectrogram magnitudes in the surrounding matching region 1312. The electronic device 1000 may change spectrogram magnitudes in the pattern matching region 1311 to the second spectrogram magnitude. That is, the electronic device 1000 may change the spectrogram magnitudes in the pattern matching region 1311 to the average of the spectrogram magnitudes in the surrounding matching region 1312. The electronic device 1000 may generate the second output audio 1320 by changing the magnitude of each of time-frequency bins corresponding to the pattern matching region 1311 in the first output audio (e.g., the harmonic region 1310), to the second spectrogram magnitude.

According to an embodiment of the disclosure, the electronic device 1000 may determine the pattern matching region 1311, which is estimated to contain harmonic components of a target sound, within the harmonic region 1310. By changing the spectrogram magnitudes in the pattern matching region 1311, which is estimated to contain harmonic components, to the average of the spectrogram magnitudes in the surrounding matching region 1312, the electronic device 1000 may remove or attenuate the harmonic components within the harmonic region 1310. Here, by changing the spectrogram magnitudes in the pattern matching region 1311 to the average of the spectrogram magnitudes in the surrounding matching region 1312, the electronic device 1000 may remove or attenuate the harmonic components within the harmonic region 1310, while reducing a sense of incongruity between the audio components in the region where the harmonic components have been removed or attenuated and the audio components other than the harmonic components of the target sound (e.g., a voice, a background sound, or ambient noise).

The electronic device 1000 may first generate first output audio by removing audio components corresponding to a target sound from original audio, and then generate the second output audio 1320 by removing or attenuating audio components corresponding to harmonic components of the target sound from the first output audio, thereby outputting final audio (i.e., the second output audio 1320) in which the target sound and the harmonic components of the target sound in the original audio have been removed or attenuated. Accordingly, by effectively removing the target sound from the input audio, the electronic device 1000 may provide a user with final audio (i.e., the second output audio 1320) having reduced perceptual presence of the target sound. The electronic device 1000 may provide audio or video with improved quality by removing a sound recorded regardless of a user's intention.

FIG. 14A is a flowchart illustrating a method, performed by the electronic device 1000, of obtaining second output audio in which magnitudes of harmonic components have been reduced, according to an embodiment of the disclosure. FIG. 14B is a diagram illustrating an operation, performed by the electronic device 1000, of obtaining second output audio 1420 in which magnitudes of harmonic components have been reduced, according to an embodiment of the disclosure.

Operations S1410 and S1420 of FIG. 14A represent a detailed implementation of operation S250 of FIG. 2. In an embodiment of the disclosure, operations S1410 and S1420 may be performed by at least one processor 1920 (see FIG. 19) included in the electronic device 1000. Operation S1410 of FIG. 14A may be performed after operation S240 of FIG. 2 is performed.

In operation S1410 of FIG. 14A, according to an embodiment of the disclosure, the electronic device 1000 may estimate the magnitude of a target sound 1402 based on residual audio 1401.

Referring to FIG. 14B, in an embodiment of the disclosure, by removing first output audio from input audio to obtain the residual audio 1401, the electronic device 1000 may obtain the distribution of the spectrogram for the target sound 1402 predicted by the artificial intelligence model. The electronic device 1000 may estimate the average of spectrogram magnitudes of the target sound 1402 through the residual audio 1401. For example, the electronic device 1000 may obtain (e.g., calculate) the average of spectrogram magnitudes in an interval in which the target sound 1402 exists within the residual audio 1401. The electronic device 1000 may estimate the magnitude of the target sound 1402 as the average of the spectrogram magnitudes in the interval in which the target sound 1402 exists, which is obtained through the residual audio 1401.

In operation S1420 of FIG. 14A, according to an embodiment of the disclosure, the electronic device 1000 may reduce first spectrogram magnitudes in a region 1411 within a target interval, which is matched with a pattern region, based on the magnitude of the target sound 1402.

FIG. 14B exemplarily illustrates a window region 1410 that is determined as a harmonic region because its attention score is greater than or equal to a preset threshold score. Hereinafter, the window region 1410 of FIG. 14B will be referred to as a harmonic region 1410. Referring to FIG. 14B, in an embodiment of the disclosure, the harmonic region 1410 may include the region 1411 matched with the pattern region of the filter (also referred to as a pattern matching region 1411) and a region 1412 matched the surrounding region of the filter (also referred to as a surrounding matching region 1412).

In an embodiment of the disclosure, the electronic device 1000 may reduce spectrogram magnitudes in the pattern matching region 1411 based on the magnitude of the target sound 1402 estimated through the residual audio 1401. For example, the electronic device 1000 may reduce the spectrogram magnitudes in the pattern matching region 1411 by applying a scaling factor of (1/magnitude of target sound). The electronic device 1000 may generate the second output audio 1420 by reducing the magnitude of each of the time-frequency bins corresponding to the pattern matching region 1411 in the first output audio by a factor of (1/magnitude of target sound).

According to an embodiment of the disclosure, the electronic device 1000 may determine the pattern matching region 1411, which is estimated to contain harmonic components of the target sound 1402, within the harmonic region 1410. By applying a scaling factor corresponding to the reciprocal of the magnitude of the target sound 1402 to the spectrogram magnitudes in the pattern matching region 1411, which is estimated to contain harmonic components, the electronic device 1000 may reduce the magnitudes of the harmonic components in proportion to the magnitude of the target sound 1402. For example, the magnitude of the target sound 1402 may generally be proportional to the magnitudes of the harmonic components of the target sound. When the magnitude of the target sound 1402 is large, the magnitudes of the harmonic components of the target sound 1402 may also be large, and when the magnitude of the target sound 1402 is small, the magnitudes of the harmonic components of the target sound 1402 may also be small. According to an embodiment of the disclosure, by determining the degree of reduction of the magnitudes of the harmonic components in proportion to the magnitude of the target sound 1402, the electronic device 1000 may attenuate harmonic components with large magnitudes to a relatively large degree and attenuate harmonic components with small magnitudes to a relatively small degree. Accordingly, by attenuating the harmonic components corresponding to their inherent magnitudes, the electronic device 1000 may reduce a sense of incongruity between the audio components in the region where the harmonic components have been removed or attenuated and the audio components other than the harmonic components of the target sound (e.g., a voice, a background sound, or ambient noise).

The electronic device 1000 may first generate first output audio by removing audio components corresponding to the target sound 1402 from original audio, and then generate the second output audio 1420 by removing or attenuating audio components corresponding to harmonic components of the target sound 1402 from the first output audio, thereby outputting final audio (i.e., the second output audio 1420) in which the target sound 1402 and the harmonic components of the target sound 1402 in the original audio have been removed or attenuated. Accordingly, by effectively removing the target sound 1402, the electronic device 1000 may provide a user with final audio (i.e., the second output audio 1420) having reduced perceptual presence of the target sound 1402. The electronic device 1000 may provide audio or video with improved quality by removing a sound recorded regardless of a user's intention.

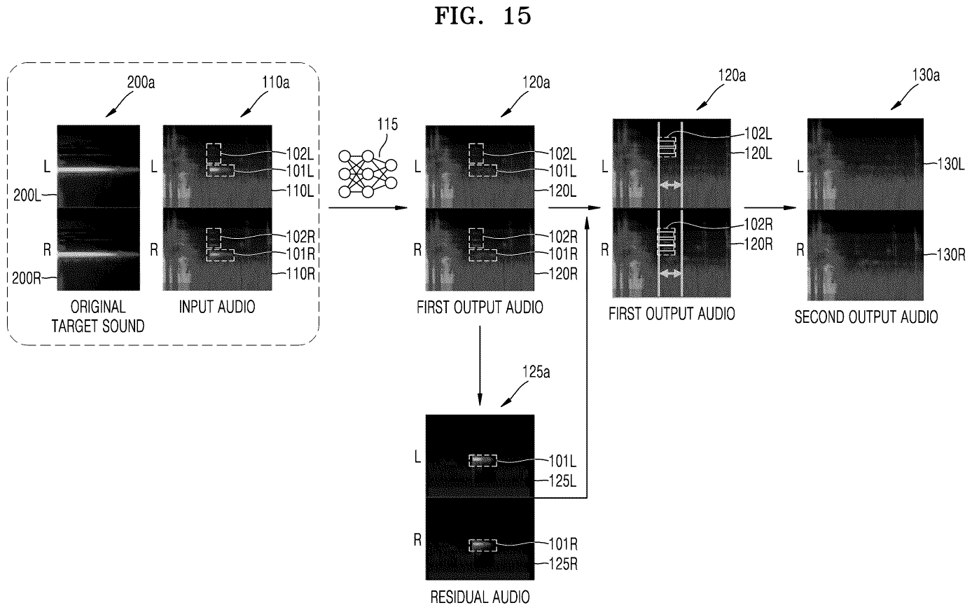

FIG. 15 is a diagram illustrating an operation, performed by the electronic device 1000, of removing a target sound from input audio 110a, according to an embodiment of the disclosure.

Referring to FIG. 15, in an embodiment of the disclosure, the input audio 110a may include left-side input audio 110L and right-side input audio 110R. The input audio 110a may be stereophonic audio. Stereophonic audio may be an audio signal that is recorded and played by using a plurality of audio channels including a ‘left’ channel and a ‘right’ channel. A stereophonic audio may provide a three-dimensional sound, because it may reproduce the directionality and depth of a sound compared to monophonic audio that uses a single channel.

In an embodiment of the disclosure, the electronic device 1000 may obtain (e.g., record) the left-side input audio 110L through a left-side microphone of the electronic device 1000 (or an external device), and obtain (e.g., record) the right-side input audio 110R through a right-side microphone of the electronic device 1000 (or an external device) that is arranged at a certain distance from the left-side microphone.

Alternatively, in an embodiment of the disclosure, the electronic device 1000 may obtain a stereophonic audio by converting (or rendering) monophonic audio by using software. For example, based on monophonic audio, the electronic device 1000 may generate the left-side input audio 110L and the right-side input audio 110R by artificially applying a time delay or frequency filtering to form a difference between the left and right channels.

In an embodiment of the disclosure, an original target sound 200a may include a left-side original target sound 200L and a right-side original target sound 200R. For example, the left-side original target sound 200L may be a result of obtaining the target sound through a left microphone, and the right-side original target sound 200R may be a result of obtaining the target sound through a right microphone. Alternatively, for example, the left-side original target sound 200L and the right-side original target sound 200R may be obtained by converting (or rendering) an original target sound in a single-channel (mono) format by using software.

In an embodiment of the disclosure, the electronic device 1000 may obtain first output audio 120a including first left-side output audio 120L and first right-side output audio 120R. The electronic device 1000 may obtain the first left-side output audio 120L by removing a target sound 101L from the left-side input audio 110L by using the artificial intelligence model 115. The target sound 101L included in the left-side input audio 110L may be referred to as a left-side target sound 101L. The electronic device 1000 may obtain the first right-side output audio 120R by removing a target sound 101R from the right-side input audio 110R by using the artificial intelligence model 115. The target sound 101R included in the right-side input audio 110R may be referred to as a right-side target sound 101R.

In an embodiment of the disclosure, the electronic device 1000 may obtain residual audio 125a including left-side residual audio 125L and right-side residual audio 125R. The electronic device 1000 may obtain the left-side residual audio 125L including the left-side target sound 101L, by using a difference between the left-side input audio 110L and the first left-side output audio 120L. The electronic device 1000 may obtain the right-side residual audio 125R including the right-side target sound 101R, by using a difference between the right-side input audio 110R and the first right-side output audio 120R.

In an embodiment of the disclosure, the electronic device 1000 may estimate features of the left-side target sound 101L based on the left-side residual audio 125L. The electronic device 1000 may estimate features of the right-side target sound 101R based on the right-side residual audio 125R. For example, the electronic device 1000 may obtain a left-side pattern map corresponding to the features of the left-side target sound 101L, and a right-side pattern map corresponding to the features of the right-side target sound 101R.

In an embodiment of the disclosure, based on the estimated features of the left-side target sound 101L (e.g., the left-side pattern map), the electronic device 1000 may search for harmonic components of the left-side target sound 101L within the first left-side output audio 120L. The electronic device 1000 may search for harmonic components of the right-side target sound 101R within the first right-side output audio 120R, based on the estimated features of the right-side target sound 101R (e.g., the right-side pattern map).

In an embodiment of the disclosure, the electronic device 1000 may obtain second output audio 130a including second left-side output audio 130L and second right-side output audio 130R. The electronic device 1000 may obtain the second left-side output audio 130L by reducing the magnitudes of the found harmonic components in the first left-side output audio 120L. The electronic device 1000 may obtain the second right-side output audio 130R by reducing the magnitudes of the found harmonic components in the first right-side output audio 120R.

According to an embodiment of the disclosure, the electronic device 1000 may obtain the second left-side output audio 130L resulting from removing or attenuating both the left-side target sound 101L and harmonic components 102L of the left-side target sound 101L from the left-side input audio 110L, and obtain the second right-side output audio 130R resulting from removing or attenuating both the right-side target sound 101R and harmonic components 102R of the right-side target sound 101R from the right-side input audio 110R. Accordingly, the electronic device 1000 may obtain final stereophonic output audio (i.e., the second output audio 130a) in which the target sound from the stereophonic input audio 110a has been effectively removed or attenuated.

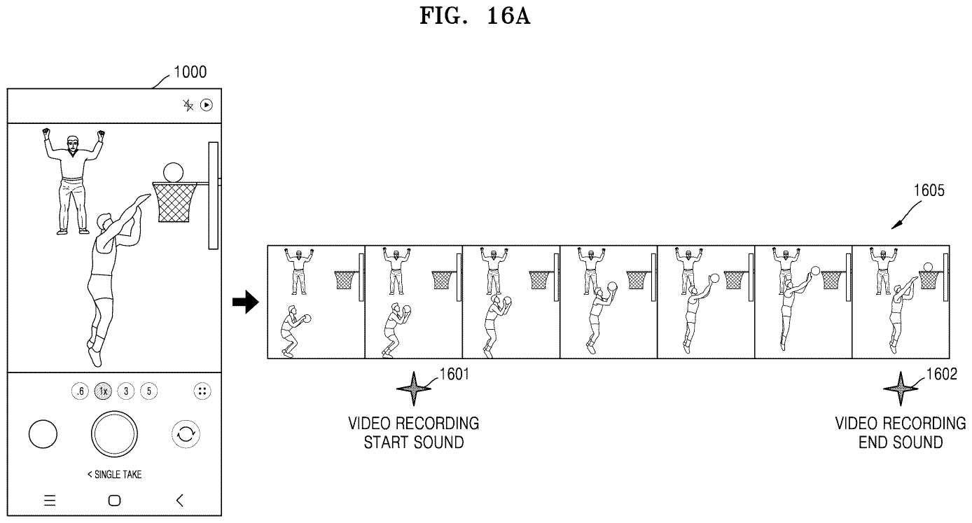

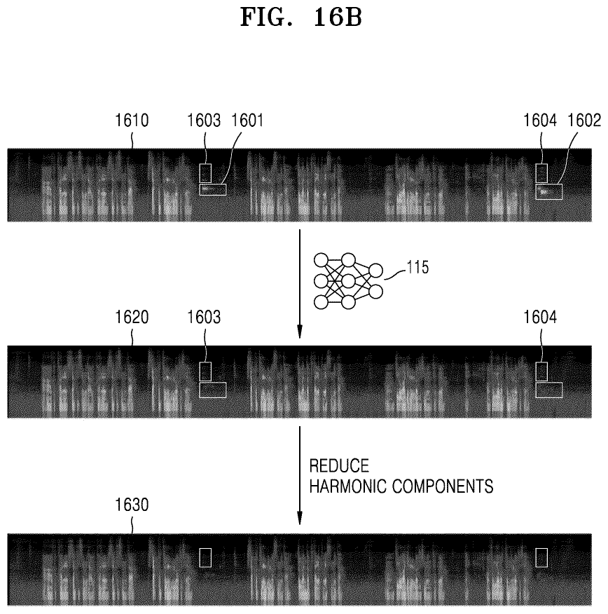

FIG. 16A is a diagram illustrating an operation, performed by the electronic device 1000, of removing a target sound from input audio 1610, according to an embodiment of the disclosure. FIG. 16B is a diagram illustrating an operation, performed by the electronic device 1000, of removing a target sound and harmonic components of the target sound from the input audio 1610, according to an embodiment of the disclosure.

Referring to FIG. 16A, in an embodiment of the disclosure, the electronic device 1000 may include a “Single Take” recording function. The Single Take recording function is a function that automatically generates various types of content (e.g., a photograph, video, a GIF, or a timelapse) by using artificial intelligence technology for a defined (e.g., predefined or predetermined) recording duration, when a user performs a single input to start recording. For example, upon receiving a user's input to start recording, the electronic device 1000 may continuously record video for a defined (e.g., predefined or predetermined) time period (e.g., for 3 seconds to 15 seconds after receiving the input). The electronic device 1000 may generate various types of content based on data included in the recorded video. For example, the electronic device 1000 may provide a best shot by selecting a photograph that captures the ideal moment. For example, the electronic device 1000 may provide short video that focuses on dynamic moments or major scenes. For example, the electronic device 1000 may convert short video in which a particular motion is repeated into a GIF file. For example, the electronic device 1000 may provide a timelapse by compressing a particular scene. Through this, the electronic device 1000 may provide a user with a plurality of optimized results with a single recording action, without the user needing to select a recording mode in advance or adjust the timing.

In an embodiment of the disclosure, the electronic device 1000 may obtain the input audio 1610 that includes a video recording start sound 1601 and a video recording end sound 1602. For example, after receiving a user's input to start Single Take recording, the electronic device 1000 may start recording video after a preset time period has elapsed, and the video recording start sound 1601 may be played when the recording starts. In this case, the video recording start sound 1601 may be recorded in original video 1605 captured during the Single Take recording. For example, after receiving a user's input to start Single Take recording, the electronic device 1000 may end the video recording after a preset time period has elapsed, and the video recording end sound 1602 may be played when the recording ends. In this case, the video recording end sound 1602 may be recorded in the original video 1605 captured during the Single Take recording.

Referring to FIG. 16B, in an embodiment of the disclosure, the input audio 1610 may include a first target sound 1601 corresponding to the video recording start sound, and a second target sound 1602 corresponding to the video recording end sound.

In an embodiment of the disclosure, the electronic device 1000 may obtain first output audio 1620 by removing the first target sound 1601 from the input audio 1610 by using the artificial intelligence model 115. For example, the electronic device 1000 may input, to the artificial intelligence model 115, the input audio 1610 and an original target sound corresponding to the first target sound 1601 (hereinafter, referred to as a first original target sound). The electronic device 1000 may obtain the first output audio 1620 resulting from removing the first target sound 1601 from the input audio 1610, based on the input audio 1610 and the first original target sound by using the artificial intelligence model 115.

In an embodiment of the disclosure, the electronic device 1000 may obtain first output audio 1620 by removing the second target sound 1602 from the input audio 1610 by using the artificial intelligence model 115. For example, the electronic device 1000 may input, to the artificial intelligence model 115, the input audio 1610 and an original target sound corresponding to the second target sound 1602 (hereinafter, referred to as a second original target sound). The electronic device 1000 may obtain the first output audio 1620 resulting from removing the second target sound 1602 from the input audio 1610, based on the input audio 1610 and the second original target sound by using the artificial intelligence model 115.

In an embodiment of the disclosure, the electronic device 1000 may reduce the magnitudes of harmonic components 1603 of the first target sound 1601 (hereinafter, referred to as first harmonic components 1603) in the first output audio 1620, to obtain the second output audio 1630 in which the first harmonic components 1603 of the first target sound 1601 have been removed or attenuated. For example, the electronic device 1000 may obtain residual audio, which includes the first target sound 1601, by using a difference between the first output audio 1620 and the input audio 1610. The electronic device 1000 may estimate features of the first target sound 1601 based on the residual audio. Based on the features of the first target sound 1601, the electronic device 1000 may search for the first harmonic components 1603 within the first output audio 1620 and may reduce the magnitudes of the found first harmonic components 1603.

In an embodiment of the disclosure, the electronic device 1000 may reduce the magnitudes of harmonic components 1604 of the second target sound 1602 (hereinafter, referred to as second harmonic components 1604) in the first output audio 1620, to obtain the second output audio 1630 in which the second harmonic components 1604 of the second target sound 1602 have been removed or attenuated. For example, the electronic device 1000 may obtain residual audio, which includes the second target sound 1602, by using a difference between the first output audio 1620 and the input audio 1610. The electronic device 1000 may estimate features of the second target sound 1602 based on the residual audio. Based on the features of the second target sound 1602, the electronic device 1000 may search for the second harmonic components 1604 within the first output audio 1620 and may reduce the magnitudes of the searched second harmonic components 1604.

Through this, the electronic device 1000 may obtain final output audio (i.e., the second output audio 1630) resulting from removing or attenuating the video recording start sound (corresponding to the first target sound 1601) and the harmonic components 1603 of the video recording start sound from the input audio 1610. The electronic device 1000 may obtain final output audio (i.e., the second output audio 1630) resulting from removing or attenuating the video recording end sound (corresponding to the first target sound 1602) and the harmonic components 1604 of the video recording end sound from the input audio 1610. Therefore, even when the video recording start/end sounds are recorded in the input audio 1610, the electronic device 1000 may estimate the features of the actual video recording start/end sounds within the input audio 1610, and based on the features of the actual video recording start/end sounds, it may more accurately search for and reduce the harmonic components 1603 and 1604 of the video recording start/end sounds. By effectively removing the video recording start/end sounds from the input audio 1610, the electronic device 1000 may provide a user with final audio (i.e., the second output audio 1630) having reduced perceptual presence of the video recording start/end sounds.

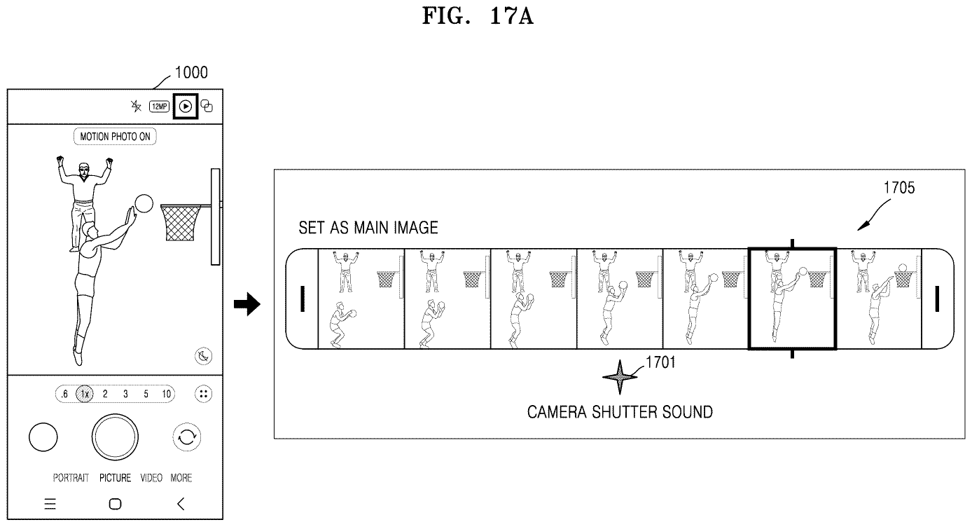

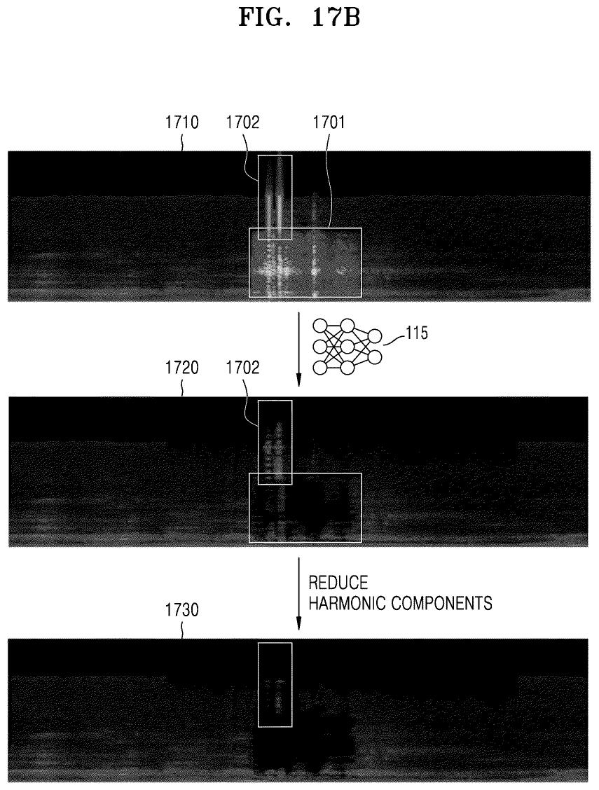

FIG. 17A is a diagram illustrating an operation, performed by the electronic device 1000, of removing a target sound from input audio, according to an embodiment of the disclosure. FIG. 17B is a diagram illustrating an operation, performed by the electronic device 1000, of removing a target sound and harmonic components of the target sound from input audio, according to an embodiment of the disclosure.

Referring to FIG. 17A, in an embodiment of the disclosure, the electronic device 1000 may include a “Motion Photo” recording function. The Motion Photo recording function is a function of recording short video before and after a time point of taking a photograph. For example, upon receiving a user input of pressing a shutter button, the electronic device 1000 may automatically record short video (e.g., video of 2 to 3 seconds in length) from immediately before the shutter button is pressed to immediately after the shutter button is pressed. By automatically recording short video, the electronic device 1000 may provide, as video, a moment that captures the movement or liveliness of a subject that cannot be conveyed by a still photograph. Even when the user's timing in pressing the shutter button is not perfect, the electronic device 1000 may select a well-captured moment from the automatically recorded short video, thereby reducing the failure rate of photography.

In an embodiment of the disclosure, the electronic device 1000 may obtain input audio 1710 that includes a camera shutter sound 1701. For example, after receiving a user's input to start Motion Photo recording, the electronic device 1000 may start video recording at a time point preceding the time point of receiving the input to start Motion Photo recording, and the video recording may end at a time point subsequent to the time point of receiving the input to start Motion Photo recording. Accordingly, the camera shutter sound 1701, which is played when the user presses the shutter button for Motion Photo recording, may be recorded in video 1705 that is automatically recorded during the Motion Photo recording.

Referring to FIG. 17B, in an embodiment of the disclosure, the input audio 1710 may include a target sound corresponding to the camera shutter sound 1701.

In an embodiment of the disclosure, the electronic device 1000 may obtain first output audio 1720 by removing the camera shutter sound 1701 from the input audio 1710 by using the artificial intelligence model 115. For example, the electronic device 1000 may input, to the artificial intelligence model 115, the input audio 1710 and an original camera shutter sound 1701 corresponding to the camera shutter sound. The electronic device 1000 may obtain the first output audio 1720 resulting from removing the camera shutter sound 1701 from the input audio 1710, based on the input audio 1710 and the original camera shutter sound 1701 by using the artificial intelligence model 115.

In an embodiment of the disclosure, the electronic device 1000 may reduce the magnitudes of harmonic components 1702 of the camera shutter sound 1701 in the first output audio 1720, to obtain second output audio 1730 in which the harmonic components 1702 of the camera shutter sound 1701 have been removed or attenuated. For example, the electronic device 1000 may obtain residual audio, which includes the camera shutter sound 1701, by using a difference between the first output audio 1720 and the input audio 1710. Based on the residual audio, the electronic device 1000 may estimate features of the camera shutter sound 1701 within the input audio 1710. Based on the features of the camera shutter sound 1701, the electronic device 1000 may search for the harmonic components 1702 of the camera shutter sound 1701 within the first output audio 1720, and reduce the magnitudes of the found harmonic components 1702.

Through this, the electronic device 1000 may obtain final output audio (i.e., the second output audio 1730) resulting from removing or attenuating the camera shutter sound 1701 and the harmonic components 1702 of the camera shutter sound 1701 from the input audio 1710. Therefore, even when the camera shutter sound 1701 is recorded in the input audio 1710, the electronic device 1000 may estimate the features of the actual camera shutter sound 1701 within the input audio 1710, and based on the features of the actual camera shutter sound 1701, it may more accurately search for and reduce the harmonic components 1702 of the camera shutter sound 1701. By effectively removing the camera shutter sound 1701 from the input audio 1710, the electronic device 1000 may provide a user with final audio (i.e., the second output audio 1730) having reduced perceptual presence of the camera shutter sound 1701.

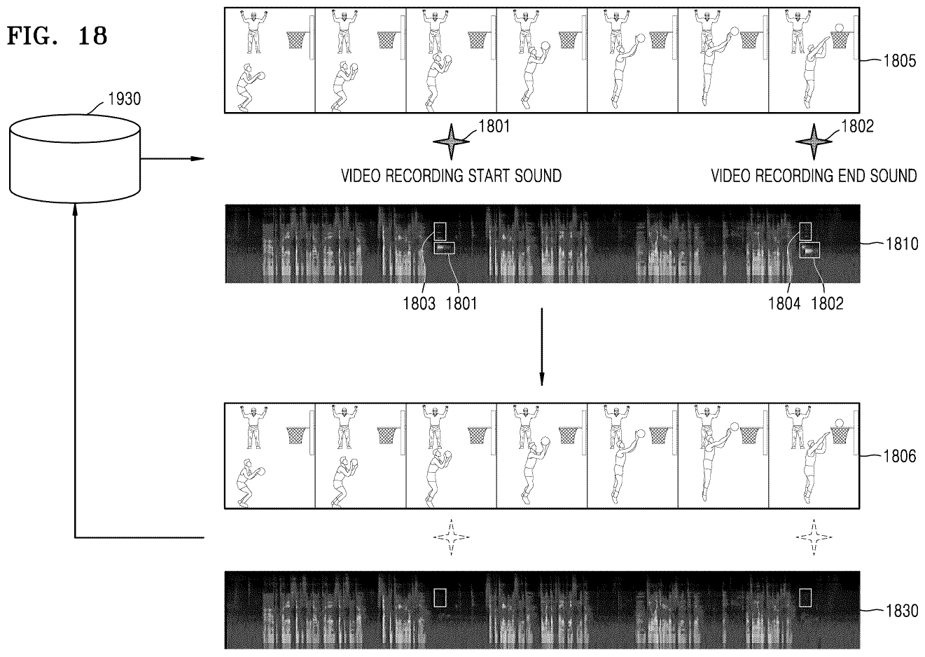

FIG. 18 is a diagram illustrating an operation, performed by the electronic device 1000, of removing a target sound from input audio 1810, according to an embodiment of the disclosure.

Referring to FIG. 18, in an embodiment of the disclosure, the electronic device 1000 may store, in memory 1930, the input audio 1810 including one or more target sounds. The electronic device 1000 may load (or obtain) the input audio 1810 including one or more target sounds 1801 and 1802, which is stored in the memory 1930, and process the input audio 1810.

In an embodiment of the disclosure, the electronic device 1000 may receive a user input requesting removal of the target sounds 1801 and 1802 from the previously stored input audio 1810. For example, the electronic device 1000 may receive a user input regarding a request to select the input audio 1810 stored in the electronic device 1000 and to remove the target sounds 1801 and 1802 from the selected input audio 1810. Based on receiving the user input regarding the request to remove the target sounds 1801 and 1802 from the input audio 1810, the electronic device 1000 may remove or attenuate the target sounds 1801 and 1802 and harmonic components 1803 and 1804 of the target sounds 1801 and 1802 from the selected input audio 1810. The electronic device 1000 may generate final output audio (e.g., second output audio 1830) resulting from removing or attenuating the target sounds 1801 and 1802 and the harmonic components 1803 and 1804 of the target sounds 1801 and 1802 from the selected input audio 1810, and store the generated final output audio in the memory 1930.

Alternatively, in an embodiment of the disclosure, the electronic device 1000 may receive a user input requesting final captured video 1806 (or final recorded audio) resulting from removing the target sounds 1801 and 1802 from original captured video 1805, at the time of video capturing (or audio recording). At the end of video capturing, the electronic device 1000 may temporarily store the captured (or recorded) input audio 1810 (or the original audio) in the memory 1930. The electronic device 1000 may load the temporarily stored input audio 1810 (or original audio) and generate final output audio (i.e., the second output audio 1830) by removing or attenuating the target sounds 1801 and 1802 and the harmonic components 1803 and 1804 of the target sounds 1801 and 1802 within the input audio 1810 (or original audio). Subsequently, the electronic device 1000 may overwrite the input audio 1810 (or original audio) stored in the memory 1930, with the final output audio (i.e., the second output audio 1830). However, an embodiment of the disclosure is not limited thereto, and the electronic device 1000 may also generate the final captured video 1806 in which the target sounds 1801 and 1802 and the harmonic components 1803 and 1804 of the target sounds 1801 and 1802 have been removed or attenuated, in real time while capturing video (or recording audio). In this case, at the end of video capturing, the electronic device 1000 may store, in the memory 1930, the final captured video 1806 (or the second output audio 1830) in which the target sounds 1801 and 1802 and the harmonic components 1803 and 1804 of the target sounds 1801 and 1802 have been removed or attenuated. Because the method of removing or attenuating the target sounds 1801 and 1802 and the harmonic components 1803 and 1804 of the target sounds 1801 and 1802 from the original audio 1810 has been described in detail above, descriptions thereof will be omitted.

FIG. 19 is a block diagram schematically illustrating a configuration of an electronic device according to an embodiment of the disclosure.

Referring to FIG. 19, the electronic device 1000 according to an embodiment of the disclosure may include an input/output interface 1910, a processor 1920, and the memory 1930.

The input/output interface 1910 may include an input interface (e.g., a touch screen, a keyboard, or a microphone) for receiving a command or information from a user, and an output interface (e.g., a display panel or a speaker) for displaying an execution result of an operation according to the user's command or a state of the electronic device 1000. According to an embodiment of the disclosure, the electronic device 1000 may receive an input (e.g., a sound source separation request) from a user through the input/output interface 1910, and when the operation is completed, output a result of performing the operation (e.g., a sound source separation result) through the input/output interface 1910.

The processor 1920 is a component configured to control a series of processes for the electronic device 1000 to operate according to embodiments of the disclosure, and may include one or more processors. The one or more processors included in the processor 1920 may be circuitry, such as a system-on-chip (SoC) or an integrated circuit (IC). The one or more processors included in the processor 1920 may be general-purpose processors such as CPUs, MPUs, APs, or DSPs, dedicated graphics processors such as GPUs or VPUs, dedicated artificial intelligence processors such as NPUs, or dedicated communication processors such as CPs. In a case in which the one or more processors included in the processor 1920 are dedicated artificial intelligence processors, the dedicated artificial intelligence processors may be designed with a hardware structure specialized for processing a particular artificial intelligence model.

The processor 1920 may write data in the memory 1930 or read data stored in the memory 1930, and in particular, may execute a program or at least one instruction stored in the memory 1930 to process data according to predefined operation rules or an artificial intelligence model. Thus, the processor 1920 may perform the operations described in embodiments of the disclosure, and the operations described herein as being performed by modules included in the electronic device 1000 may be regarded as being performed by the processor 1920, unless otherwise specified.

The memory 1930 is a component for storing various programs or data, and may include a storage medium such as read-only memory (ROM), random-access memory (RAM), a hard disk, a compact disc ROM (CD-ROM), or a digital video disc (DVD), or a combination of storage media. The memory 1930 may not be a separate component and may be included in the processor 1920. The memory 1930 may include volatile memory, nonvolatile memory, or a combination of volatile memory and nonvolatile memory. The memory 1930 may store a program or at least one instruction for performing the operations according to embodiments of the disclosure described herein. The memory 1930 may provide data stored therein to the processor 1920 in response to a request from the processor 1920.

The embodiments of the disclosure described above with reference to FIGS. 1 to 18 may be performed by the electronic device 1000.

To solve the above-described technical issues, an embodiment of the disclosure provides a method, performed by an electronic device 1000, of removing a target sound 101 from input audio 110.

In an embodiment of the disclosure, the method may include obtaining first output audio 120 by removing the target sound 101 from the input audio 110 by using an artificial intelligence model 115 (S210).

In an embodiment of the disclosure, the method may include obtaining residual audio 125 including the target sound 101, by using a difference between the input audio 110 and the first output audio 120 (S220).

In an embodiment of the disclosure, the method may include estimating features of the target sound 101 based on the residual audio 125 (S230).

In an embodiment of the disclosure, the method may include determining harmonic components 102 of the target sound 101 within the first output audio 120, based on the estimated features of the target sound 101 (S240).

In an embodiment of the disclosure, the method may include obtaining second output audio 130 by reducing magnitudes of the harmonic components 102 in the first output audio 120 (S250).

In an embodiment of the disclosure, the estimating of the features of the target sound 101 (S230) may include obtaining a pattern map 300 corresponding to the features of the target sound 101 (S710).

In an embodiment of the disclosure, in the method, the pattern map 300 may correspond to a map that represents a distribution of frequency components of the target sound 101 over time in a time-frequency domain.

In an embodiment of the disclosure, the determining the harmonic components 102 within the first output audio 120 (S240) may include estimating, based on the residual audio 125, a target interval in which the target sound 101 exists in a spectrogram of the input audio 110 (S910).

In an embodiment of the disclosure, the searching for the harmonic components 102 within the first output audio 120 (S240) may include searching for the harmonic components 102 by using a filter corresponding to the pattern map 300, while shifting the filter within the target interval by a defined (e.g., predefined or predetermined) frequency step (S920).

In an embodiment of the disclosure, in the method, the filter corresponding to the pattern map 300 may include a pattern region where the harmonic components 102 exist, and a surrounding region other than the pattern region.

In an embodiment of the disclosure, the searching for the harmonic components 102 within the first output audio 120 (S240) may further include calculating, for each of window regions in the target interval which are sequentially matched with the filter, an attention score corresponding to a ratio of an average of first spectrogram magnitudes in a region matched with the pattern region to an average of second spectrogram magnitudes in a region matched with the surrounding region (S1110).

In an embodiment of the disclosure, the searching for the harmonic components 102 within the first output audio 120 (S240) may further include determining, based on the attention score of each of the window regions, at least one window region from among the window regions, as at least one harmonic region that includes the harmonic components 102 (S1120).

In an embodiment of the disclosure, the determining of the at least one window region as the at least one harmonic region (S1120) may include determining, as the at least one harmonic region, at least one window region whose attention score falls within a preset top percentage, from among the window regions.

In an embodiment of the disclosure, the obtaining (e.g., generating) of the second output audio 130 by reducing the magnitudes of the harmonic components 102 (S250) may include changing the first spectrogram magnitudes within the at least one harmonic region to the average of the second spectrogram magnitudes (S1310).

In an embodiment of the disclosure, the obtaining (e.g., generating) of the second output audio 130 by reducing the magnitudes of the harmonic components 102 (S250) may include estimating a magnitude of the target sound 101 based on the residual audio 125 (S1410).

In an embodiment of the disclosure, the obtaining (e.g., generating) of the second output audio 130 by reducing the magnitudes of the harmonic components 102 (S250) may include reducing, based on the magnitude of the target sound 101, the first spectrogram magnitudes within the at least one harmonic region (S1420).

In an embodiment of the disclosure, the obtaining of the first output audio 120 (S210) may include obtaining the first output audio 120 resulting from removing the target sound 101 from the input audio 110, by applying, to the artificial intelligence model 115, the input audio 110 and an original target sound 200 corresponding to the target sound 101 (S410).

In an embodiment of the disclosure, the artificial intelligence model 115 may include a lightweight model stored in the electronic device 1000.

In an embodiment of the disclosure, in the method, the target sound 101 may include a system notification sound including at least one of a video recording start sound, a video recording end sound, or a camera shutter sound.

In an embodiment of the disclosure, in the method, the input audio 110 may include left-side input audio 110L and right-side input audio 110R.

To solve the above-described technical issues, an embodiment of the disclosure provides an electronic device 1000. An embodiment of the disclosure may provide the electronic device 1000 for removing a target sound 101 from input audio 110.

In an embodiment of the disclosure, the electronic device 1000 may include memory 1930 storing instructions, and at least one processor 1920 operatively coupled to the memory 1930 and including processing circuitry.

In an embodiment of the disclosure, the at least one processor 1920 may individually or collectively execute the instructions to cause the electronic device 1000 to obtain first output audio 120 by removing the target sound 101 from the input audio 110 by using an artificial intelligence model 115.

In an embodiment of the disclosure, the at least one processor 1920 may individually or collectively execute the instructions to cause the electronic device 1000 to obtain residual audio 125 including the target sound 101, by using a difference between the input audio 110 and the first output audio 120.

In an embodiment of the disclosure, the at least one processor 1920 may individually or collectively execute the instructions to cause the electronic device 1000 to estimate features of the target sound 101 based on the residual audio 125.

In an embodiment of the disclosure, the at least one processor 1920 may individually or collectively execute the instructions to cause the electronic device 1000 to determine harmonic components 102 of the target sound 101 within the first output audio 120, based on the estimated features of the target sound 101.

In an embodiment of the disclosure, the at least one processor 1920 may individually or collectively execute the instructions to cause the electronic device 1000 to obtain second output audio 130 by reducing magnitudes of the harmonic components 102 in the first output audio 120.

In an embodiment of the disclosure, the at least one processor 1920 may individually or collectively execute the instructions to cause the electronic device 1000 to obtain a pattern map 300 corresponding to the features of the target sound 101.

In the electronic device 1000 according to an embodiment of the disclosure, the pattern map 300 may correspond to a map that represents a distribution of frequency components of the target sound 101 over time in a time-frequency domain.

In an embodiment of the disclosure, the at least one processor 1920 may individually or collectively execute the instructions to cause the electronic device 1000 to estimate, based on the residual audio 125, a target interval in which the target sound 101 exists in a spectrogram of the input audio 110.

In an embodiment of the disclosure, the at least one processor 1920 may individually or collectively execute the instructions to cause the electronic device 1000 to search for the harmonic components 102 by using a filter corresponding to the pattern map 300, while shifting the filter within the target interval by a defined (e.g., predefined or predetermined) frequency step.

In the electronic device 1000 according to an embodiment of the disclosure, the filter corresponding to the pattern map 300 may include a pattern region where the harmonic components 102 exist, and a surrounding region other than the pattern region.

In an embodiment of the disclosure, the at least one processor 1920 may individually or collectively execute the instructions to cause the electronic device 1000 to calculate, for each of window regions in the target interval which are sequentially matched with the filter, an attention score corresponding to a ratio of an average of first spectrogram magnitudes in a region matched with the pattern region to an average of second spectrogram magnitudes in a region matched with the surrounding region.

In an embodiment of the disclosure, the at least one processor 1920 may individually or collectively execute the instructions to cause the electronic device 1000 to determine, based on the attention score of each of the window regions, at least one window region from among the window regions, as at least one harmonic region that includes the harmonic components 102.

In an embodiment of the disclosure, the at least one processor 1920 may individually or collectively execute the instructions to cause the electronic device 1000 to change the first spectrogram magnitudes within the at least one harmonic region to the average of the second spectrogram magnitudes within the surrounding region.

In an embodiment of the disclosure, the at least one processor 1920 may individually or collectively execute the instructions to cause the electronic device 1000 to estimate a magnitude of the target sound 101 based on the residual audio 125.

In an embodiment of the disclosure, the at least one processor 1920 may individually or collectively execute the instructions to cause the electronic device 1000 to reduce, based on the magnitude of the target sound 101, the first spectrogram magnitudes within the at least one harmonic region.

In an embodiment of the disclosure, the at least one processor 1920 may individually or collectively execute the instructions to cause the electronic device 1000 to obtain the first output audio 120 resulting from removing the target sound 101 from the input audio 110, by applying, to the artificial intelligence model 115, the input audio 110 and an original target sound 200 corresponding to the target sound 101.

A machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

According to an embodiment of the disclosure, methods according to various embodiments of the disclosure may be included in a computer program product and then provided. The computer program product may be traded as a commodity between sellers and buyers. The computer program product may be distributed in the form of a machine-readable storage medium (e.g., a CD-ROM), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or memory of a relay server.

What is claimed is:

1. A method for removing a target sound from an input audio, the method being performed by an electronic device, and the method comprising:
obtaining a first output audio based on removing the target sound from the input audio by using an artificial intelligence model;
obtaining residual audio including the target sound, based on a difference between the input audio and the first output audio;
estimating features of the target sound based on the residual audio;
determining harmonic components of the target sound in the first output audio, based on the estimated features of the target sound; and
obtaining second output audio based on reducing magnitudes of the harmonic components in the first output audio.

2. The method of claim 1, wherein the estimating of the features of the target sound comprises obtaining a pattern map associated with the features of the target sound.

3. The method of claim 2, wherein the pattern map is a map representing a distribution of frequency components associated with the target sound over time in a time-frequency domain.

4. The method of claim 2, wherein the determining the harmonic components comprises:
estimating, based on the residual audio, a target interval in which the target sound is present in a spectrogram of the input audio; and
determining the harmonic components based on shifting a filter in the target interval by a defined frequency step wherein the filter is associated with the pattern map.

5. The method of claim 4, wherein the filter comprises a pattern region where the harmonic components are present, and a surrounding region other than the pattern region, and
the determining the harmonic components further comprises:
calculating, for each window region in the target interval that match the filter, an attention score, the attention score being based on a ratio of an average of first spectrogram magnitudes in a window region that matches the pattern region to an average of second spectrogram magnitudes in a window region that matches the surrounding region; and
determining, based on the attention score of each window region, at least one window region from among window regions, as at least one harmonic region that includes the harmonic components.

6. The method of claim 5, wherein the determining of the at least one window region as the at least one harmonic region comprises determining, as the at least one harmonic region, the at least one window region whose attention score falls within a preset top percentage, from among the window regions.

7. The method of claim 5, wherein the obtaining of the second output audio by reducing the magnitudes of the harmonic components comprises changing the first spectrogram magnitudes within the at least one harmonic region to the average of the second spectrogram magnitudes.

8. The method of claim 5, wherein the obtaining of the second output audio by reducing the magnitudes of the harmonic components comprises:
estimating a magnitude of the target sound based on the residual audio; and
reducing, based on the magnitude of the target sound, the first spectrogram magnitudes within the at least one harmonic region.

9. The method of claim 1, wherein the obtaining the first output audio comprises obtaining the first output audio based on the input audio, an original target sound corresponding to the target sound, and the artificial intelligence model.

10. The method of claim 1, wherein the artificial intelligence model comprises a lightweight model stored in the electronic device.

11. The method of claim 1, wherein the target sound comprises a system notification sound comprising at least one of a video recording start sound, a video recording end sound, or a camera shutter sound.

12. The method of claim 1, wherein the input audio comprises left-side input audio and right-side input audio.

13. An electronic device for removing a target sound from input audio, the electronic device comprising:
memory storing instructions; and
at least one processor operatively coupled to the memory and comprising processing circuitry,
wherein the at least one processor is configured to, individually or collectively, execute the instructions to cause the electronic device to:
obtain a first output audio based on removing the target sound from the input audio by using an artificial intelligence model,
obtain residual audio including the target sound, based on a difference between the input audio and the first output audio,
estimate features of the target sound based on the residual audio,
determine harmonic components of the target sound in the first output audio, based on the estimated features of the target sound, and
obtain second output audio based on reducing magnitudes of the harmonic components in the first output audio.

14. The electronic device of claim 13, wherein the at least one processor is further configured to, individually or collectively, execute the instructions to cause the electronic device to obtain a pattern map associated with the features of the target sound,
wherein the pattern map is a map representing a distribution of frequency components of the target sound over time in a time-frequency domain.

15. The electronic device of claim 14, wherein the at least one processor, is further configured to, individually or collectively execute the instructions to cause the electronic device to:
estimate, based on the residual audio, a target interval in which the target sound is present in a spectrogram of the input audio, and
determine the harmonic components based on shifting a filter in the target interval by a defined frequency step, wherein the filter is associated with the pattern map.

16. The electronic device of claim 15, wherein the filter comprises a pattern region where the harmonic components are present, and a surrounding region other than the pattern region, and
wherein the at least one processor, is further configured to, individually or collectively execute the instructions to cause the electronic device to:
to calculate, for each window region in the target interval that match the filter, an attention score, the attention score being based on a ratio of an average of first spectrogram magnitudes in a window region that matches the pattern region to an average of second spectrogram magnitudes in a window region that matches the surrounding region, and
determine, based on the attention score of each window region, at least one window region from among window regions, as at least one harmonic region that includes the harmonic components.

17. The electronic device of claim 16, wherein the at least one processor, is further configured to, individually or collectively execute the instructions to cause the electronic device to change the first spectrogram magnitudes in the at least one harmonic region to the average of the second spectrogram magnitudes in the surrounding region.

18. The electronic device of claim 16, wherein the at least one processor, is further configured to, individually or collectively execute the instructions to cause the electronic device to:
estimate a magnitude of the target sound based on the residual audio, and
reduce, based on the magnitude of the target sound, the first spectrogram magnitudes within the at least one harmonic region.

19. The electronic device of claim 13, wherein the at least one processor is further configured to, individually or collectively, execute the instructions to cause the electronic device to: obtain the first output audio based on the input audio, an original target sound corresponding to the target sound, and the artificial intelligence model.

20. A non-transitory computer-readable medium storing instructions that, when executed by at least one processor of an electronic device, cause the electronic device to:
obtain first output audio based on removing a target sound from the input audio by using an artificial intelligence model;
obtain residual audio including the target sound, based on a difference between the input audio and the first output audio;
estimate features of the target sound based on the residual audio;
determine harmonic components of the target sound within the first output audio, based on the estimated features of the target sound; and
obtain second output audio based on reducing magnitudes of the harmonic components in the first output audio.
